(19) United States
(12) Patent Application Publication
(10) Pub. No.: US 2021/0039102 A1
(43) Pub. Date: Feb. 11, 2021

(54) METHODS AND SYSTEMS FOR DESIGNING AND PRODUCING NANO-STRUCTURED OPTICAL DEVICES

(71) Applicant: Arizona Board of Regents on Behalf of the University of Arizona, Tucson, AZ (US)

(72) Inventors: Euan McLeod, Tucson, AZ (US); Weilin Liu, Tucson, AZ (US); Jeffrey Melzer, Tucson, AZ (US)

(73) Assignee: Arizona Board of Regents on Behalf of the University of Arizona, Tucson, AZ (US)

(21) Appl. No.: 16/966,841

(22) PCT Filed: Feb. 1, 2019
(86) PCT No.: PCT/US2019/016409

§ 371 Date: Jul. 31, 2020

Related U.S. Application Data
(60) Provisional application No. 62/624,868, filed on Feb. 1, 2018.

(51) Int. Cl. B01L 3/00; G02B 1/00; G02B 21/32; G21K 1/00

(52) U.S. Cl. CPC B01L 3/502761; G02B 1/005; B82Y 30/00; G21K 1/006; G02B 21/32

(57) ABSTRACT

A method of designing a nano-structured optical device includes: selecting a first nanoscale building block from a finite set of types of building blocks; placing the first nanoscale building block at a position and orientation in a three-dimensional optical device structure; optimizing the position, orientation, and type of the first nanoscale building block to obtain a preselected optical effect based on optical scattering from the first nanoscale building block; selecting a second nanoscale building block from the finite set of types of building blocks; placing the second nanoscale building block at a position and orientation in the three-dimensional optical device structure along with the first nanoscale building block; and optimizing the positions, orientations, and types of the first and second nanoscale building blocks to obtain the preselected optical effect based on optical scattering from the first and second nanoscale building blocks.

### CROSS-REFERENCE TO RELATED APPLICATIONS

This application claims priority benefit from U.S. Provisional Patent Application No. 62/624,868 filed on Feb. 1, 2018, the entire content of which is incorporated herein by reference. All references cited anywhere in this specification, including the Background and Detailed Description sections, are incorporated by reference as if each had been individually incorporated.

### FEDERAL FUNDING

This invention was made with government support under Grant No. 1807590, awarded by NSF and Grant No. HDTRA-11810044 awarded by Defense Threat Reduction Agency. The government has certain rights in the invention.

### BACKGROUND

### 1. Technical Field

The field of the currently claimed embodiments of this invention relates to methods and systems for designing and producing nano-structured devices, and more particularly to methods and systems for designing and producing nano-structured optical devices.

### 2. Discussion of Related Art

Nanostructured two-dimensional (2D) phased arrays and metasurfaces are currently receiving great interest due to their ability to redirect light, control polarization, and operate across a wide bandwidth with an ultra-thin form factor. While 2D structures have many uses, three-dimensional (3D) structures provide additional degrees of freedom with which to control light: beyond simply re-directing light, a 3D structure can guide and translate light. A 3D structure can also offer a potentially smaller footprint than a corresponding 2D structure, e.g. an input/output coupler from a waveguide that is much smaller than conventional grating couplers. Furthermore, 3D photonic nanostructures that operate at visible wavelengths can serve as cost-effective testing platforms for larger real-world structures that interact with microwave and radio wavelengths. Additionally, understanding and controlling the scattering of light in 3D is also critical in sensing naval targets and in designing naval equipment.

To date, 3D photonic nanostructures have received less interest than their 2D counterparts because of several challenges, including the fact that: (1) conventional modeling methodologies are so slow that they hinder iterative design approaches, and (2) there do not exist fabrication approaches that are capable of constructing structures with the necessary resolution out of heterogeneous photonic materials. 2D metasurface design approaches such as generalized laws of refraction and reflection do not translate well to 3D geometries, while conventional 3D modeling approaches like finite difference time domain (FDTD) simulation are too computationally demanding to be used in large-scale iterative design problems.

Existing fabrication techniques such as self-assembly, two-photon polymerization, photolithography, e-beam lithography, or conventional 3D printing cannot create complex 3D structures with sub-100 nm resolution out of multiple materials. Mixing multiple materials with different relative permittivities is critical in many nanophotonic applications. In addition, most existing techniques are too slow, costly, and labor-intensive for rapid prototyping and small-batch production. Finally, these established techniques are in general unsuitable for augmenting existing structures, as may be required in the hierarchical manufacturing of devices where one desires to add nanoscale components on top of mesoscale structures.

Many applications could benefit from improved design and prototyping of three-dimensional nanophotonic imaging and sensing devices. One such application is the integration of on-chip light field imaging with other imaging modalities in small and light-weight optical systems. Light field imaging, also known as integral imaging or plenoptic imaging, captures the angular distribution of incident light rays as well as their intensities and positions on the image sensor. This ray angle information enables 3D imaging, as well as computational refocusing of images and synthesis of images with arbitrary depth of field. Currently, there are three main approaches used to capture light field images: microlens arrays, coded apertures, and angle-sensitive pixels based on diffraction gratings. In all of these approaches, there is a tradeoff between the spatial resolution and the amount of angular information acquired, because, for a single point on the object, tens to hundreds of individual pixels are required to measure the angular distribution of light rays leaving that point. This results in the spatial resolution at the image plane being governed by an effective “super-pixel” size that is typically 50-200 μm, which is significantly larger than the pixel sizes used in conventional digital cameras. Smaller pixel sizes are key enablers of compact and light-weight optical systems that utilize small diameter and short focal length optics without sacrificing field of view or resolution. Thus, the size and weight of current light-field imaging systems is limited by their effective super-pixel size.

One possible solution to the problem of large super-pixels might be to shrink the size of the individual pixels while conserving the number of pixels per super-pixel in order to maintain the angular resolution. Unfortunately, for light field imaging systems based on microlenses, coded apertures, or gratings, diffraction places a physical limit on the minimum useful pixel size; reducing the pixel size below λ/(2 NA) would provide no additional information. Here, NA is the effective numerical aperture of the microlenses, coded apertures, or grating system, and typically has a value significantly smaller than one. 3D nanophotonic structures that filter light according to angle (and also polarization and wavelength), and then guide that light toward a particular pixel with nanoscale confinement could enable non-redundant pixels smaller than λ/2, super-pixels on the order of a few microns, and ultimately, significantly smaller and lighter optical systems.

Each of the three current light field imaging approaches also has its own particular disadvantages that could be mitigated via 3D nanostructures. When using microlens arrays there are either dead zones where pixels receive no light or there is cross-talk where a given pixel can receive light from neighboring microlenses. The diffraction grating approach has only been demonstrated where the gratings and imaging chip are fabricated monolithically, which increases the time and cost involved in prototyping different architectures, and prevents the adaptation of high-performance commercial image sensors into light-field imagers. Furthermore, the pixels are necessarily relatively large (e.g., 7.5 μm) because they each need to consist of several periods of a diffraction grating.

Therefore, there remains a need for improved methods and systems for designing and producing nano-structured optical devices.

### SUMMARY

A method of designing a nano-structured optical device according to an embodiment of the current invention includes selecting a first nanoscale building block from a finite set of types of building blocks. Each type of building block has at least a defined shape, size and compositional material characteristic. The method also includes placing the first nanoscale building block at a position and orientation in a three-dimensional optical device structure, optimizing the position, orientation, and type of the first nanoscale building block to obtain a preselected optical effect based on optical scattering from the first nanoscale building block, selecting a second nanoscale building block from the finite set of types of building blocks, placing the second nanoscale building block at a position and orientation in the three-dimensional optical device structure along with the first nanoscale building block, optimizing the positions, orientations, and types of the first and second nanoscale building blocks to obtain the preselected optical effect based on optical scattering from the first and second nanoscale building block. The optical device designed has the three-dimensional optical device structure.

A nano-assembly system according to an embodiment of the current invention includes a nano-scale-building-block selection and delivery system having an input section and an assembly region, a nano-positioning system arranged proximate the assembly region, and a nano-assembly control system configured to communicate with the nano-scale-building-block selection and delivery system to select nano-scale building blocks to be delivered to the assembly region according to an assembly plan. The nano-assembly control system is further configured to communicate with the nano-positioning system for the nano-positioning system to position nano-scale building blocks that have been delivered to the assembly region according to the assembly plan.

A method of producing a nano-structured device according to an embodiment of the current invention includes receiving a production plan, selecting a first nanoscale building block from a finite set of types of building blocks using the production plan. Each type of building block has at least a defined shape, size and compositional material characteristic. The method also includes placing the first nanoscale building block at a position in a three-dimensional device structure using the production plan, selecting a second nanoscale building block from the finite set of types of building blocks using the production plan, placing the second nanoscale building block at a position in the three-dimensional device structure along with the first nanoscale building block using the production plan, and repeating the selecting, placing and optimizing a plurality of times using the production plan to provide the nano-structured device.

A nano-structured device according to an embodiment of the current invention is produced according to a method according to an embodiment of the current invention.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIGS. 1A-1E provide a comparison between a coupled dipole method and finite difference time domain, in accordance with an embodiment.

FIG. 2 is a graph of the speed of the coupled dipole method, in accordance with an embodiment.

FIGS. 3A-3D provide a schematic representation and graph of OPCODE-generated structure for waveguide to fiber out-coupling, in accordance with an embodiment.

FIGS. 4A-4F provide a schematic representation and graph of a coupled dipole method simulation of a large structure, in accordance with an embodiment.

FIGS. 5A-5E show imaging of the performance of nanophotonic transmission line structures with different material compositions, in accordance with an embodiment.

FIGS. 6A-6C provide a schematic representation of a nano-assembly platform in accordance with an embodiment.

FIG. 7 is a graph of building block manipulation speeds, in accordance with an embodiment.

FIG. 8 is a graph of particle detection using a quadrant photodiode, in accordance with an embodiment.

FIGS. 9A-9D provide a series of images showing linking building blocks to each other and to a substrate, in accordance with an embodiment.

FIGS. 10A-10B show a gel electrophoresis analysis and graph of particle functionalization, in accordance with an embodiment.

FIGS. 11A-11C provide a schematic representation of angular sensitivity with sub-micron pixels, in accordance with an embodiment.

FIGS. 12A-12B provide a schematic representation of pixel superstructures for larger, conventional micron-scale pixels, in accordance with an embodiment.

FIG. 13A is a diagram showing the forces acting upon a bead in an optical trap. Here, the particle is being moved along the positive y direction, which causes displacement in the opposite direction. The optical force, denoted F_{grad}, pulls the particle back toward the center of the trap, while the frictional force, written as F_{drag}, tends to push the particle out of the trap.

FIG. 13B shows a typical trap velocity and distance traveled during a single manipulation trial. In this case, the particle is accelerated at 50 μm/s2 and travels at the peak velocity of 200 μm/s for a distance of 1 mm.

FIG. 14 shows experimental trapping speeds over a large power range from 2 mW to 450 mW for various bead sizes and materials. The larger dielectric beads are not limited by any fundamental phenomenon at these powers, but instead restricted from faster movement due to destabilizing stage vibrations at speeds faster than 225 μm/s. The nanoparticles, on the other hand, cannot be manipulated faster due to increasing trap instability at higher powers, which places a fundamental limit on maximum trapping speed of approximately 155 μm/s for the 100 nm gold and silver beads and 170 microns/second for the 160 nm polystyrene beads.

FIGS. 15A-15D show optical trap forces calculated using the T-matrix method (λ=1064 nm, P=100 mW) for polystyrene spheres. (a) As particles are displaced laterally from the trap center, they experience an increasing restoring force up to some maximum value. Generally, the larger particles interact more with the focused beam, resulting in stronger trapping forces. (b) The T-matrix and Rayleigh predictions of maximum trapping force agree for smaller particles, but diverge for sizes greater than ˜λ/2 due to the inaccuracy of the Rayleigh approximation at these sizes (dashed line). (c-d) For particle diameters below ˜1000 μm, the maximum trapping force increases with larger values of numerical aperture. For larger particles, the behavior is more complex, with microspheres having optimal values of NA for which trapping force is maximized (vertical dashed lines in (d)). The optimal NA is shown to decrease with increasing particle size.

FIGS. 16A-16C show maximum experimental trapping speeds as a function of trap power for (a) microparticles and (b) nanoparticles in the linear regime. We compute the slopes of these experimental data and compare to theoretical calculations in (c). Shades of blue indicate data corresponding to polystyrene beads, while red and yellow data correspond to silver and gold beads, respectively. Error bars signify 95% confidence intervals on the fitted parameters to the slopes of the experimental data. Calculations for metals use n_{Ag}=0.0885+7.768i and n_{Au}=0.135±7.437i. The metallic theory line cuts off around a size of 200 nm, indicating the loss in axial trapping for larger metallic particles. Although forces may still be computed in the transverse plane, we only consider regions of 3D trap stability.

FIGS. 17A-17D show axial well depth normalized by k_{B}^{T} as a function of particle diameter and laser power for (a) gold, (b) silver, and (c) polystyrene. The region of viable trapping is bounded by the white (Brownian motion limit) and magenta (water vaporization limit) dotted lines. The results for 100 nm particles are plotted separately in (d) to demonstrate the distinction between the different materials.

FIG. 18 shows a microscope image of an array of particles that have been attached to a substrate using a system according to an embodiment of the current invention.

FIG. 19 shows the power spectrum of a 100 nm diameter gold nanoparticle that we have trapped according to an embodiment of the current invention.

FIG. 20 is similar to FIG. 19, but the particle is a 110 nm diameter polystyrene particle.

FIG. 21 is again data from a quadrant photodiode, but the data is shown in the time domain and is the total electrical signal over the whole active area of the photodiode, and not a difference signal, as was shown in the previous figures.

FIG. 22 shows more time-series data from a quadrant photodiode.

FIG. 23 shows our procedure for recalibrating our positioning system according to an embodiment of the current invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

A method of designing a nano-structured optical device according to an embodiment of the current invention includes selecting a first nanoscale building block from a finite set of types of building blocks. Each type of building block has at least a defined shape, size and compositional material characteristic. This method also includes placing the first nanoscale building block at a position in a three-dimensional optical device structure, and optimizing the position and type of the first nanoscale building block to obtain a preselected optical effect based on optical scattering from the first nanoscale building block.

This method further includes selecting a second nanoscale building block from the finite set of types of building blocks, placing the second nanoscale building block at a position in the three-dimensional optical device structure along with the first nanoscale building block, and optimizing the positions and types of the first and second nanoscale building blocks to obtain the preselected optical effect based on optical scattering from the first and second nanoscale building block. The optical device designed has the three-dimensional optical device structure.

The term “nanoscale building block” refers to a nanostructure that is less than 1 μm in all dimensions. A building block of a particular type is such a nanostructure that has a specific shape, size and composition. For example, a plurality of building blocks of a particular type are all of the same size, shape and composition to within the acceptable tolerance for the particular application. The term “block” does not imply a particular shape. For example, the shapes of types of nanoscale building blocks can be, but are not limited to, spherical, elliptical, cubical, rectangular, cylindrical, pyramidal, or any other of a wide range of geometrical or other more complex shapes.

The “optimizing” means that the type of the nanoscale building block is exchanged with another type and/or the position of the nanoscale building block is modified so that the optical device better performs the intended function. Optimizing does not necessarily indicate that the type and position of the nanoscale building block is exactly at the best value. The replacing and modifying can be carried out until the design function of the optical device is sufficiently close to the intended function and/or until improvements over previous iterations become sufficiently small. The broad concepts of the current invention are not limited to one specific optimization method. For example, evolutionary algorithms, genetic algorithms, particle swarm optimization, and/or differential evolution could be used. However, the broad concepts of the current invention are not limited to these examples.

The term “optical scattering” can have a broad definition to include elastic and/or inelastic scattering. For example, without limitation, Rayleigh, Raman and Mie scattering can be included in various embodiments. In some embodiments, especially for building blocks that are small relative to the wavelength of light for which the optical device is designed to function, the optical scattering can be approximated as Rayleigh scattering. In some embodiments, it can be the actually observed scattered electromagnetic radiation.

The terms light and optical, etc. are not intended to be limited to only visible light. It refers to electromagnetic radiation more generally such that it can include ultraviolet, infrared and/or millimeter wave light according to some embodiments.

In some embodiments, the selecting, placing and optimizing can be repeated a number of times to provide the design of the optical device. The broad concepts of the current invention are not limited to the particular number of times those step are repeated. It could be as few as two or three, or it could be tens of times, hundreds of times, thousands of times, or even many more.

In some embodiments, all of the selecting, placing and optimizing are performed virtually using at least one computer. This can be considered as a modeling, simulation and/or computer aided design process. In some embodiments, the optimizing can include performing a plurality of calculations in which each building block is approximated as an electric dipole which can interact with other approximated electric dipoles within the three-dimensional optical device structure. In some embodiments, a building block could be approximated as two or more electric dipoles according to this approach. In some embodiments, the optimal positioning of coupled optical dipole elements (OPCODE) approach can be used. This is described in more detail below. However, this is a particular embodiment of the current invention. The broad concepts of this invention are not limited to only this embodiment.

In some other embodiments, all of the selecting, placing and optimizing are performed physically using a nano-assembly system. In this case, the function of the device being assemble can be observed as it is assembled. Empirical information would then be used in the optimization process. In some embodiments, the nano-assembly system can be, but I not limited to, a nano-assembly system according to some embodiments of the current invention which will be described in more detail below. For example, the nano-assembly system used according to an embodiment can include a microfluidic building-block delivery system and an optical tweezers building-block positioning system. However, the broad concepts of this method are not limited to only that nano-assembly system.

In some embodiments, the method can include storing a production plan for the three-dimensional optical device structure for use with controlling a manufacturing system.

Some embodiments of methods of designing nano-structured optical devices according to embodiments of the current invention will now be described in more detail. The broad concepts of the current invention are not limited to these particular examples.

Accordingly, an embodiment of the current invention is directed to a system and method for designing 3D structures. An embodiment is a rapid nanophotonic approach called optimal positioning of coupled optical dipole elements (OPCODE) combined with a novel rapid prototyping approach called optical positioning and linking (OPAL) in order to augment existing image sensors to create ultra-compact light field imaging devices that also measure other optical properties such as polarization.

The OPCODE design approach uses the coupled dipole method (also known as the discrete dipole approximation) inside an optimization loop to rapidly calculate scattered near and far fields from particle arrays. Unlike traditional FDTD or finite element nanophotonics simulation methods, the run time for a single OPCODE iteration scales with the number of nanophotonic elements, rather than the simulation domain size. This means that when the number of photonic elements is modest (e.g. several hundred), simulations can run on time scales of hundredths of a second, where the same FDTD simulation would have taken minutes. This makes it feasible to run iterative optimization routines with many free parameters.

For these optimization routines, particle-based optimization variables are selected: number of particles, particle materials, particle sizes, and separation distances. This choice of variables makes OPCODE fundamentally different from so-called topological optimization, or free-form iterative optimization, where a domain is divided into pixels or voxels, and the material of each of those voxels can be chosen. As a result, OPCODE is better suited to “bottom-up” fabrication methods such as directed- or self-assembly instead of “top-down” methods such as e-beam lithography or focused ion beam milling. According to an embodiment, the design approach is selected in concert with a fabrication approach in order to ensure feasible and robust designs that take full advantage of all the capabilities offered by the fabrication approach. According to an embodiment, the OPCODE approach could prove advantageous for any type of nanophotonic assembly based on nanoscale building blocks rather than lithography.

To demonstrate the benefits of the OPCODE design approach, simulations were conducted comparing the accuracy and speed of the coupled dipole method, which lies at the core of the OPCODE approach, versus conventional FDTD simulations. Both types of simulations were run on the same machine, a 2.60 GHz Intel Xeon E5-2660 with 256 GB of RAM. The OPCODE routine was programmed in MATALB, while the FDTD simulations were all run using Lumerical's commercial FDTD Solutions software, using a total field/scattered field (TFSF) method. The FDTD simulations were allowed to progress until they converged, as detected automatically by Lumerical's software.

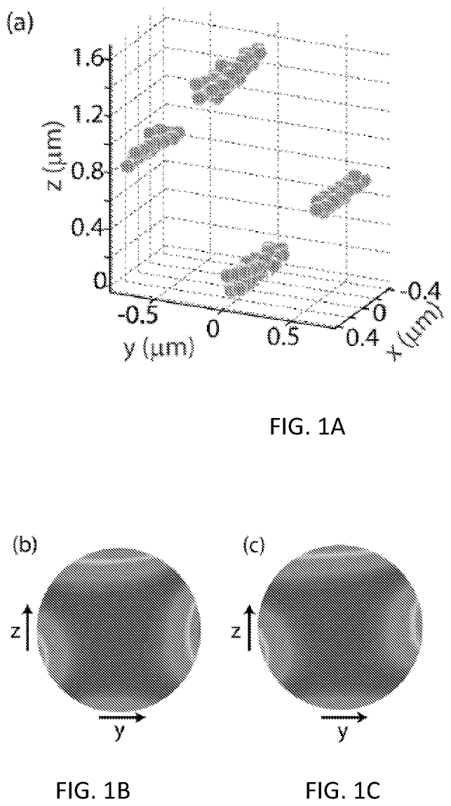

The simulation results were qualitatively compared between the coupled dipole method and FDTD for 3D arrays of particles in free-space. FIGS. 1A-1E provide a comparison between the coupled dipole method (CDM) and FDTD. FIG. 1A is the 3D structure of 100 nanoparticles each with diameter 100 nm; FIG. 1B is the far-field scattering pattern for light incident in the positive y direction with wavelength 1550 nm, calculated by CDM, and viewed from the positive x-axis; FIG. 1C is the far-field scattering pattern calculated by FDTD with a far-field projection, using the FDTD method; FIG. 1D is the scattered intensity along the positive z-axis (z) versus number of particles in the structure (N); and FIG. 1E is the simulation time as a function of N.

FIG. 1A depicts one of these structures that is composed of 100 nm gold nanoparticles whose positions were generated using the OPCODE approach in order to efficiently scatter incident light travelling in the positive y-direction into light that travels in the positive z-direction. FIG. 1B shows the far-field scattering pattern as viewed from the positive x-axis that is calculated using the coupled dipole method. FIG. 1C shows the corresponding pattern obtained via FDTD simulation followed by a far-field projection, which compares favorably with the coupled dipole method.

The coupled dipole approach is quantitatively compared to FDTD in terms of the far-field intensity along the z-axis (FIG. 1D) as well as the time required to perform a single simulation (FIG. 1E). The results of two different FDTD simulation settings are shown: a slow simulation where the grid spacings are roughly 20 nm (a “Mesh Accuracy” setting of 8) and a fast simulation where the grid spacings are roughly 80 nm (a “Mesh Accuracy” setting of 1). Even at the low accuracy setting, the FDTD simulations were ˜3 orders of magnitude slower than the coupled dipole method.

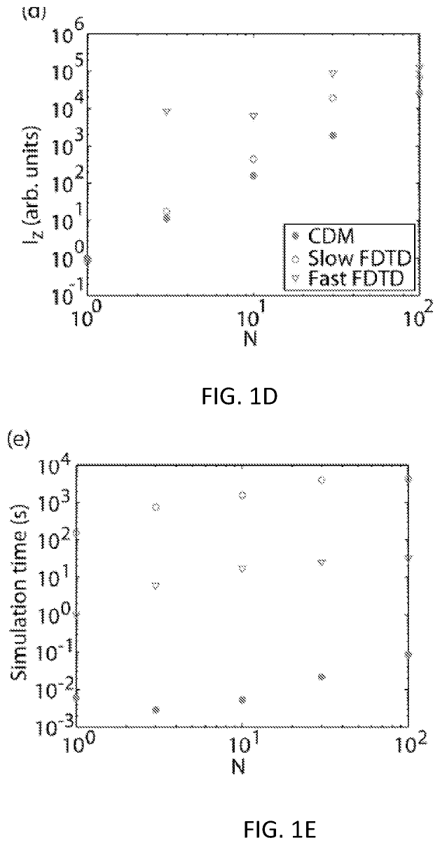

The speed of the coupled dipole method allows it to be easily integrated into an optimization loop, forming the basis of the OPCODE approach, as shown in FIG. 2. The cost function in this optimization loop is the negative logarithm of the light scattered along the positive z-axis in the far field. MATLAB's active-set constrained optimization algorithm was used to perform this optimization. This routine involved >1000 iterations, where each of these iterations requires many coupled dipole method simulations like those depicted in FIGS. 1A-1E in order to calculate finite differences, which measure how small shifts in each particle's position impact the cost function. The total time for this routine was ˜10 hours, which would have made it infeasible to run using FDTD simulations, which are >3 orders of magnitude slower.

While the free-space simulations are helpful in making fundamental comparisons between OPCODE and FDTD, many real-world applications of nanophotonics involve nanostructures that are held in close proximity to a substrate. Fortunately, analytical solutions are available for dipole-dipole coupling in proximity to a single substrate or substrate stack such as a slab waveguide. The scattered far-field from such structures can be calculated quite rapidly, while intermediate near-field coupling between dipoles that is mediated by reflections from the substrate requires a slower calculation of integrals. To keep the simulation approaches as rapid as possible, an approximate coupling calculation was used where the part of the coupling between dipoles that is due to reflections from the substrate is ignored when calculating each particle's dipole moment, but where reflections from the substrate are correctly accounted for when computing far-field scattering.

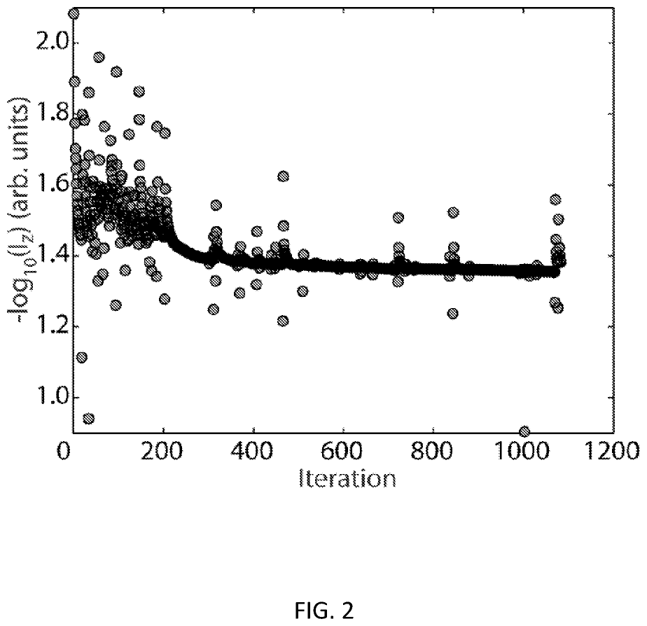

An example of how OPCODE can be used to design nanophotonic structures that are in close proximity to mesoscale structures is shown in FIGS. 3A-3D, where OPCODE is used to generate a 3D nanostructure for evanescent coupling of light out from a Si waveguide into a single-mode optical fiber placed at right angles with respect to the waveguide. This type of structure could be useful for probing and debugging photonic integrated circuits. Interestingly, the particle structure generated by the OPCODE approach includes aspects of well-known 2D grating couplers as well as aspects of 3D nanoantennas, where the particle clusters further from the waveguide surface help to direct the light being scattered out of the waveguide. In practice, this type of nanoparticle structure could be created by either embedding the nanoparticles into a polymer matrix or by using scaffolding particles that are index-matched to the background media.

FIGS. 3A-3D provide data regarding an OPCODE-generated structure for waveguide to fiber out-coupling. FIG. 3A is a side view of the structure captured from an FDTD simulation setup; FIG. 3B is a front view of structure, where the translucent gray square near the bottom of the panel is one of the FDTD field monitors; FIG. 3C is the magnitude of electric field in the single mode fiber, 90 nm from the end of the fiber; FIG. 3D is a control simulation showing that without the nanostructure, there is no significant coupling from the waveguide to the fiber. The color maps in FIG. 3C and FIG. 3D are the same.

To set up the OPCODE simulation, it was assumed that the incident excitation was given by the natural evanescent field of the Si waveguide, while the cost function being optimized was the light being scattered into the positive z-direction into the far field. A slab waveguide was also assumed instead of the stripe waveguide shown in FIGS. 3A and 3B. The OPCODE-generated structure was then imported into an FDTD simulation that included the optical fiber and stripe waveguide to see if it still performed as desired. As shown in FIGS. 3C and 3D, the nanostructure strongly enhanced the coupling of light into the fiber core, despite the approximations assumed in the OPCODE framework. This structure could serve as a starting point to help inform heuristic designs or for limited second-round optimization based on FDTD simulations.

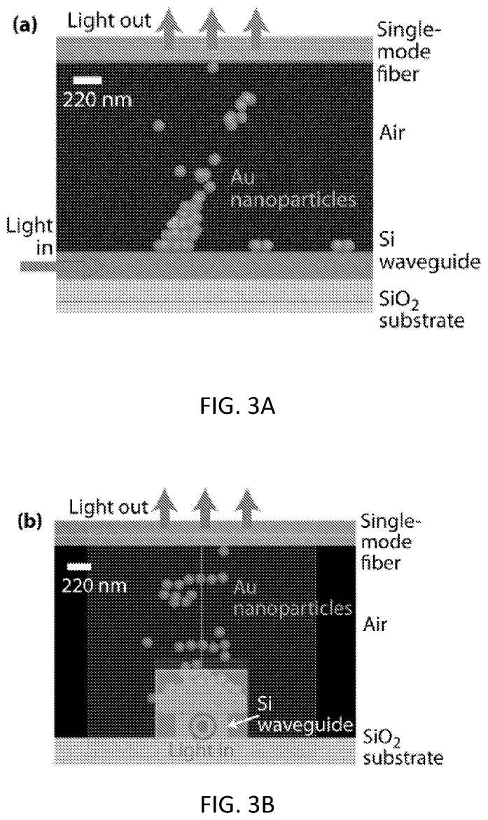

FIGS. 4A-4F show an example of a coupled dipole method simulation of a large structure, where sources are in-phase point dipoles polarized in the &direction, background media is water, free-space wavelength is 1064 nm, and a 5 nm gap is included between all particles to account for their functional coating. FIG. 4A is a 3D schematic of the simulated structure. FIG. 4B depicts light sources placed in the pattern of the numeral 7, with spacing far below the diffraction limit. FIG. 4C depicts that a conventional NA 1.1 diffraction-limited coherent imaging system would not be able to resolve the different dipole sources that make up the pattern. The observed pattern closely resembles the standard point spread function for a single light source polarized along the z-axis. FIG. 4D is a side-view cross-section of field outside nanoparticles, corresponding to the plane through the transmission lines illustrated in FIG. 4E. Light from a dipole source is “conducted” along its transmission line with minimal cross-talk into the neighboring transmission lines. FIG. 4E depicts the electric field at the output plane that shows minimal cross talk between transmission lines illuminated by sources and the “dark” transmission lines. FIG. 4F shows that the numeral 7 pattern can now be clearly resolved in the far-field by diffraction-limited coherent imaging of the light radiated out of the device. The inset shows how the pattern can be even more apparent after brightness and contrast post-processing.

The coupled dipole method can also be used to simulate large structures with many particles of different materials, as shown in FIGS. 4A-4F, where 10,681 silver and polystyrene particles are simulated. This structure was designed heuristically, and not through an optimization approach like OPCODE. It is an example of a tapered array of nanophotonic transmission lines that have been “shielded” from each other such that it is possible for them to confine light to sub-diffraction-limit volumes with minimal cross-talk among the transmission lines. It is shown here to illustrate that the coupled dipole method is scalable to reasonably large structures, as well as to demonstrate an example of a structure that requires multiple materials with different permittivities than the background media.

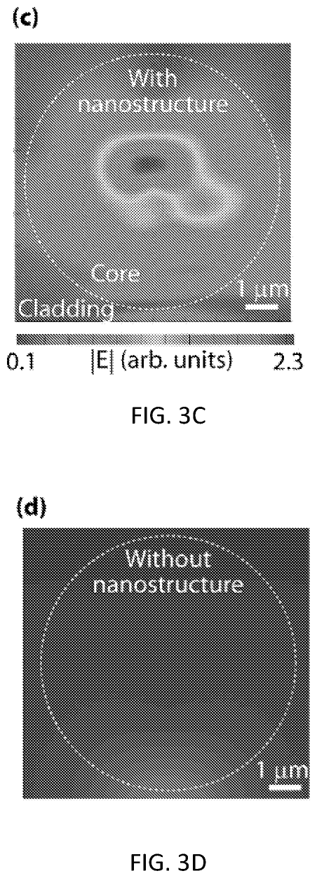

As shown in FIGS. 5A-5E, the structure fails to act as an array of shielded transmission lines when composed of a single material. FIGS. 5A-5E depict the performance of nanophotonic transmission line structures with different material compositions. FIG. 5A is the same as FIG. 4F, where both polystyrene and silver particles are used. In FIGS. 5B-5E, if the structure was built out of a single material—only polystyrene or only silver—it would fail to provide shielded sub-diffraction limit light transmission, as exhibited by the failure to accurately replicate the numeral 7 pattern.

According to one embodiment, the performance and capabilities of the OPCODE approach can be further improved, and its robustness characterized. For example, analytical gradients can be implemented, and other optimization algorithms tested, to improve performance. Because OPCODE is based on the coupled dipole method, which is a semi-analytical method, it is possible to directly compute analytical gradients that indicate how the cost function locally depends on each particle's position and size. This potential to compute gradients analytically represents another significant advantage of OPCODE over FDTD or finite element methods, which are purely numerical and would rely on finite differences in an optimization routine. Note that these finite differences correspond to the differences with respect to the optimization variables and are not the same as the “finite differences” that give the FDTD algorithm its name. The use of analytical gradients can greatly speed optimization routines by reducing the number of simulations that need to be performed in each iteration of the routine. With analytical gradients, the method can also take advantage of better optimization algorithms, such as the conjugate gradient method, or the trust-region-reflective method, which should provide additional speedups.

To extend the capabilities of OPCODE to a wider range of systems, it can be applied to multi-material systems with variable particle size. Multi-material systems can already be easily handled by the coupled dipole method through the different optical properties of each particle (see e.g., FIGS. 4A-4F). According to an embodiment, it can handle high refractive index dielectric nanoparticles, which have been shown to have similar properties to plasmonic nanoparticles, but with much lower loss. Incorporating multiple materials into the optimization loop will require an additional optimization variable for each particle, in addition to the positional coordinates. Similarly, particle size variability introduces another additional optimization variable. According to an embodiment, scaffolding constraints can be implemented into the optimization routine that ensure each nanoparticle is physically supported. This could be most applicable to cases where the scaffolds are composed of low-scattering particles that support other highly-scattering particles. With these extensions, the system can characterize the robustness of the designs in terms of small perturbations to particle sizes, positions, and/or material properties.

According to an embodiment, the capabilities of OPCODE can be extended to non-spherical building blocks such as nanorods, as well as larger, extended structures like the waveguide shown in FIGS. 3A and 3B. In many cases, a nanorod can be treated as a single dipole scatterer, although when the length of the nanorod is of order λ/2, its dipole moment cannot be calculated using the standard Rayleigh scattering formula. For extended structures, the discrete dipole approximation can be used to model those structures, which states that a bulk material is optically equivalent to a collection of dipoles whose spacing is much less than the wavelength. This collection of dipoles can then be directly incorporated into the coupled dipole method of OPCODE.

A consequence of this use of the discrete dipole approximation for extended structures will be that many more dipoles need to be handled in each simulation, which could lead to slowdowns in computation. To deal with this potential problem, alternative methods can be utilized to solve the coupled dipole simulation problem. At its core, the coupled dipole simulation approach involves a matrix inversion problem, where the matrix inverse is known to exist and to be unique. According to an embodiment, the method directly calculates the matrix inverse, which is quite fast for matrices of order 100×100, and still possible for order 10⁴×10⁴, as shown in FIGS. 4A-4F. However, this approach may become intractable for matrices on the order of 10⁵×10⁵ or larger. In these cases, an iterative optimization approach becomes faster for solving the matrix inversion problem. The overall OPCODE approach would then consist of two nested optimization routines: one for solving the coupled dipole problem in each iteration, and another for solving the overall design problem.

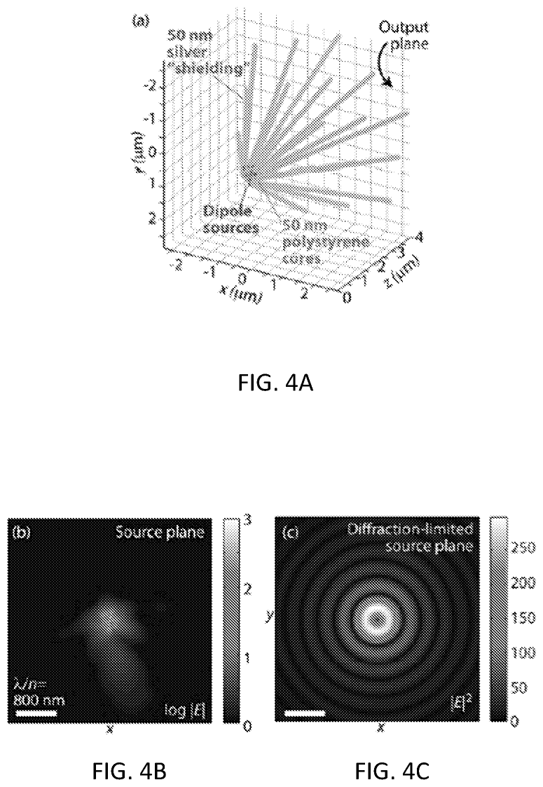

FIGS. 6A-6C is a schematic illustration of a nano-assembly system 100 according to another embodiment of the current invention. The nano-assembly system 100 includes a nano-scale-building-block selection and delivery system 102 having an input section 104 and an assembly region 106. The nano-assembly system 100 also includes a nano-positioning system 108 arranged proximate the assembly region 106. A non-limiting example of a nano-positioning system 108 is an x-y-z nano-positioning stage in combination with an optical tweezers system, as is indicated schematically in FIG. 6C. The nano-assembly system 100 also includes a nano-assembly control system 110 configured to communicate with the nano-scale-building-block selection and delivery system 102 to select nano-scale building blocks to be delivered to the assembly region 106 according to an assembly plan. The nano-assembly control system 110 is further configured to communicate with said nano-positioning system 108 for the nano-positioning system to position nano-scale building blocks that have been delivered to the assembly region 106 according to the assembly plan. A nano-structured device 112 is illustrated schematically in FIGS. 6B and 6C. In some embodiments, without limitation, the assembly plan can be for a three-dimensional optical device that includes a plurality of nano-scale building blocks assembled to have a preselected optical effect.

In some embodiments, the nano-scale-building-block selection and delivery system 102 is a microfluidic system that has a plurality of input and delivery channels each connected to a source of a type of nano-scale building block at the input section 104 such that they all connect to the assembly region 106. However, the broad concepts of this invention are not limited to this particular example of the nano-scale-building-block selection and delivery system 102. Other microfluidic device structures and/or other devices could also be used. For example, a microfluidic chip that has a control layer to provide a control valve structure could also be used in some embodiments.

In some embodiments, the nano-positioning system 108 includes optical tweezers to move the nano-scale building blocks into positions based on the assembly plan. In the example nano-positioning system 108 of FIG. 6C, the nano-positioning stage moves relative to the optical tweezers while it holds the building block stationary.

In some embodiments, the assembly plan can be based a method of designing a nano-structured optical device according to any of the above noted embodiments.

Another embodiment of the current invention is directed to a method of producing a nano-structured device. The method includes receiving a production plan, selecting a first nanoscale building block from a finite set of types of building blocks using the production plan, placing the first nanoscale building block at a position in a three-dimensional device structure using the production plan, selecting a second nanoscale building block from the finite set of types of building blocks using the production plan, placing the second nanoscale building block at a position in the three-dimensional device structure along with the first nanoscale building block using the production plan, and repeating the selecting, placing and optimizing a plurality of times using the production plan to provide the nano-structured device. Each type of building block has at least a defined shape, size and compositional material characteristic.

In some embodiments, the production plan can be a production plan generated according to any of the methods described above. For example, in some embodiments, nano-structured optical devices can be produced.

In some embodiments, the methods of production can include providing at least one of a substrate or a scaffold structure to provide support structure to each of the building block. In some embodiments, the methods of production can further include functionalizing the plurality of nanoscale building blocks and functionalizing at least one of the substrate and the scaffold to effect assembly according to the production plan.

The following provides some further examples according to some embodiments of the current invention. However, the broad concepts of this invention are not limited to these particular examples.

FIGS. 6A-6C provide a schematic representation of a nano-assembly platform according to an embodiment of the current invention. FIG. 6A is a schematic illustration of a microfluidic chip according to an embodiment of the current invention. Different materials (building blocks) will be introduced from external reservoirs using inlet ports. Although four are shown here, the general concepts of the invention are not limited to only four. There could be fewer or greater than four in some embodiments. FIG. 6B is a schematic illustration to show more details of the corresponding section of FIG. 6A. In this example, the microfluidic channels allow particles to be pumped to the threshold of an assembly chamber that is large compared to the size of the building blocks. Optical tweezers select individual particles and bring them to the desired locations. FIG. 6C is a side view of the assembly system. The microscope objective is fixed, while the whole microfluidic chip is positioned in x-y-z on a nano-positioning stage.

According to an embodiment, in order to assess the performance of the OPCODE approach, it can be benchmarked against FDTD approaches in terms of accuracy and speed of individual simulations, for example as shown in FIGS. 1A-1E. Other measures of accuracy beyond far-field scattering in a particular direction can be examined. OPCODE can also be compared to finite element simulations using COMSOL, and the simulated results can be compared to experimental results. This can be accomplished, for example, by investigating some of the free-space designs such as those presented in FIGS. 1A-1E, but where the particles are embedded in a transparent medium. The far field scattering patterns as a function of angle can be measured in a microscope system and compared to the predictions from the coupled dipole method. The robustness of the designs can play a key role here.

In contrast to existing fabrication methods, the OPAL approach is capable of fabricating structures that: (1) are 3D; (2) require nano-scale resolution; and (3) are composed of multiple materials in a complex geometry, such as those conceived in FIGS. 3A-3D and 4A-4F. OPAL can operate at room temperature and pressure, making it well-suited to assemble sensitive materials. As an additive and rapid-prototyping technique, designs or materials can be changed or substituted to fabricate entirely new structures.

According to an embodiment, a microfluidic chip defines an assembly chamber. Colloidal nanoparticle building blocks of dielectrics, plasmonic metals, semiconductors, and high refractive index dielectrics materials can be delivered to the chamber through microfluidic channels, as shown in FIGS. 6A-6C, and a computer-controlled optical tweezer can automatically pick particles and place them in specific 3D locations as elements of the final structure. As each particle is positioned, it can permanently link to the structure through aqueous chemical binding at room temperature according to some embodiments of the current invention. Optical tweezers are well-suited for the rapid placement of nanoscale particles, and have been shown to trap particles as small as 18 nm. Other groups have used optical tweezers to position particles, and in some cases join them together; however, their structures have been simple, composed only of dielectrics, and at most involved a handful of particles. This approach has not been scaled to even moderately complex structures—in contrast to what is described herein—because of the lack of simple and robust particle linkage mechanisms, as well as the complexity in creating automated pick-and-place routines.

In addition to studying the positional capability of OPAL, the systems and methods can be utilized to explore the framework for linking particles together through aqueous chemical binding. This contrasts with standard additive manufacturing approaches in which the binding of individual volume elements (voxels) is often accomplished by thermal melting/sintering or photopolymerization mechanisms. Both of these standard classes of mechanisms inherently limit the types of materials that can be added to the growing structure. For thermal adhesion mechanisms, differences in melting point, glass transition temperature, and thermal expansion coefficients can all lead to failure when trying to print composite materials. In photopolymerization mechanisms, the material must be one of the few available photopolymers, and shrinkage/swelling can be an issue when removing residual solvent from the system.

According to one embodiment, key elements of an optical trapping system include: (1) a 30 W continuous-wave laser operating at λ=1064 nm wavelength with high power stability (<2% variation) and mode quality M²<1.1; (2) a 100×/1.1 NA water immersion microscope objective corrected into the infrared; and (3) a nanopositioning stage.

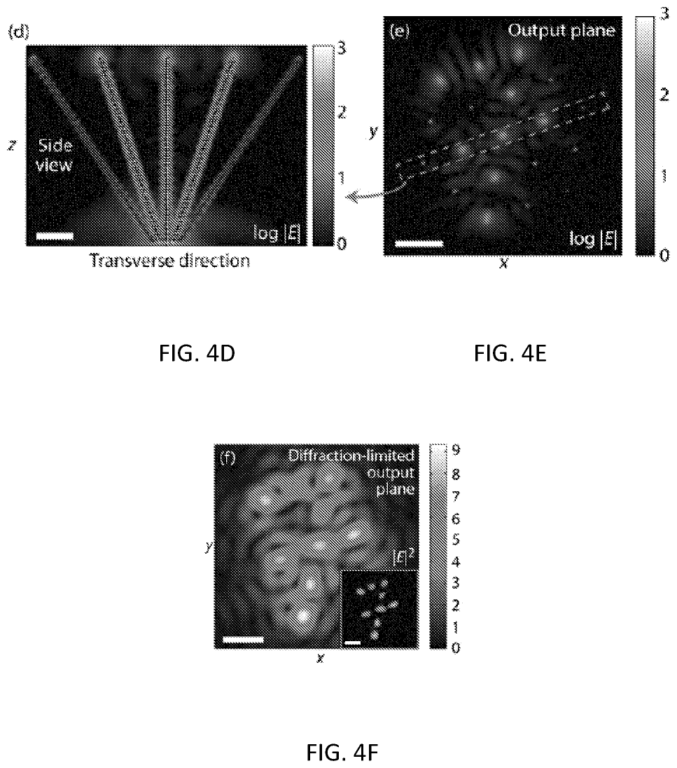

FIG. 7 shows an example of building block manipulation speeds according to an embodiment of the current invention. It shows the experimentally measured maximum manipulation speeds of polystyrene (PS), silver (Ag), and gold (Au) particles. Each data point represents the maximum speed where a particle could be manipulated across a distance of 1 mm in at least 80% of trials. Faster speeds are possible. The optical trapping system can be utilized, for example, to trap and manipulate 100 nm gold and silver particles, and polystyrene particles ranging from 510 nm to 5 μm, as shown in FIG. 7. This demonstration of the trapping of multiple types of materials is important because one of the key features of the OPAL nanomanufacturing platform is its ability to simultaneously construct structures out of multiple types of building blocks according to some embodiments of the current invention. While metals, in general, have very different optical properties from dielectrics such as silica or polystyrene, nanoparticles of both materials can be optically trapped by the same mechanism, as long as the trapping wavelength is significantly larger than the particle size, and is not particularly close to a strong plasmonic resonance of the nanoparticle.

The maximum particle manipulation speed can be quantified, which can limit the nano-manufacturing throughput. These results are shown in FIG. 7. Both nanoscale and microscale particles can be reliably manipulated at speeds >0.15 mm/s in the system. This is faster than the piezo-based writing speed of commercial two-photon polymerization systems. For both OPAL and two-photon polymerization, there are mechanisms to increase the writing speed beyond the piezo-based limit, including better hardware, spatially multiplexing the laser beam using spatial light modulators, or temporally multiplexing it using galvanometric scanners.

Theoretically, the maximum manipulation speed is governed by the force balance between the optical trap and the Stokes' drag force of the particle moving through the liquid, which leads to the maximum manipulation speed being linearly proportional to laser beam power. Experimentally, it is seen that this linear relationship holds true at low trap powers in FIG. 7. However, at high trap powers, the relationship becomes nonlinear. In the system, this is caused by vibrations in the translation stage that occur when the stage is driven at these high speeds. According to an embodiment, other mechanisms can also limit particle manipulation speed, including laser-induced material damage or other thermal effects. In these tests, only <10% of the maximum power of the laser beam was used. According to an embodiment, further future improvements to manipulation speed are possible by switching to a higher performance translation stage, modifying the filling factor of the objective, and adjusting the polarization state of the laser beam.

The speed with which automated mechanisms can load single particles into the optical trap can also be designed according to some embodiments of the current invention. An embodiment can include a rapid feedback mechanism for determining when a particle has been loaded. The approach here is to use a quadrant photodiode (QPD) to measure the backscattered light from the optical trap. A QPD can provide much faster feedback than image processing of video frames.

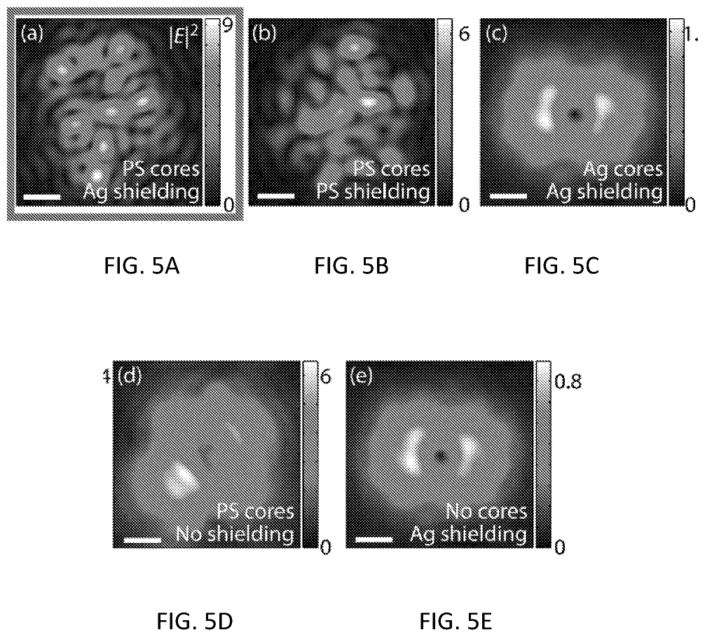

FIG. 8 shows data for an example of automated particle detection using a QPD. Using the corner frequency obtained from the power spectral density of the difference signal recorded on the QPD together with the mean backscattered intensity together provides a robust mechanism for automatically determining whether a particle has been loaded into the trap. In FIG. 8, it is shown that the frequency response and the mean backscattered intensity can be used together to determine when a particle has been loaded into the optical trap. This approach can be extended to smaller nanoscale particles.

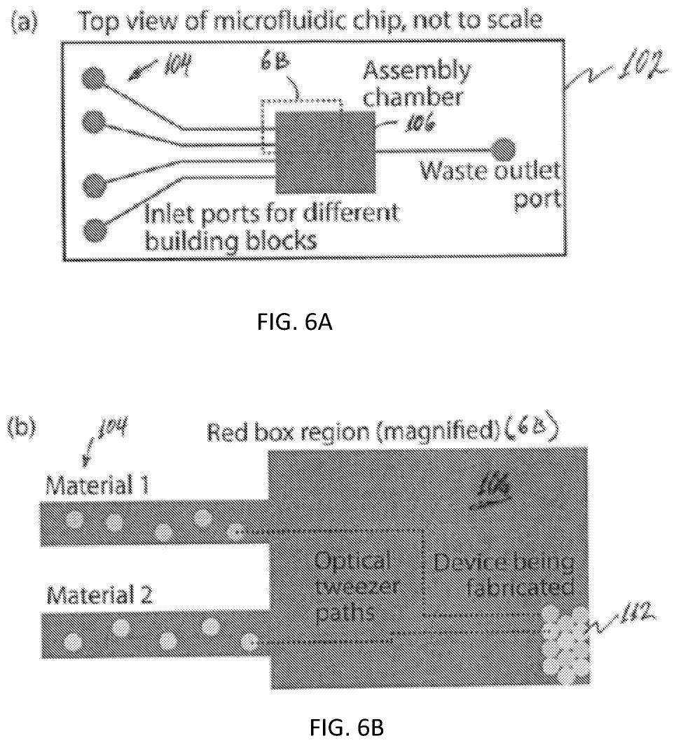

FIGS. 9A-9D show a series of images of building blocks linking to each other and to the substrate. FIG. 9A shows that streptavidin-coated (S) beads do not spontaneously bind to each other. FIG. 9B shows spontaneous binding occurs between S beads and biotin-coated (B) beads. Fluorescence imaging with background brightfield illumination shows both the non-fluorescent S beads as well as the fluorescent B beads. FIG. 9C shows a mixture of red-fluorescent plain polystyrene beads and green-fluorescent S beads. FIG. 9D shows binding of S beads to the substrate. Here, a glass slide was coated with biotin, dispensed the bead mixture shown in FIG. 9C, and then rinsed the slide. S beads remain bound to the substrate while the plain red beads are washed away.

According to one embodiment, the binding approach can be demonstrated using, for example, commercially available polystyrene beads that are delivered with either biotin or streptavidin coatings. When biotin- and streptavidin-coated beads are mixed in water, they do indeed spontaneously bind together, as shown in FIG. 9B. It is also seen that glass substrates can be functionalized with biotin in order to specifically bind streptavidin-coated beads, as shown in FIG. 9D. Functionalization of the substrate (or a small region of a substrate) can be used to form a foundation upon which to build nanostructured materials and devices.

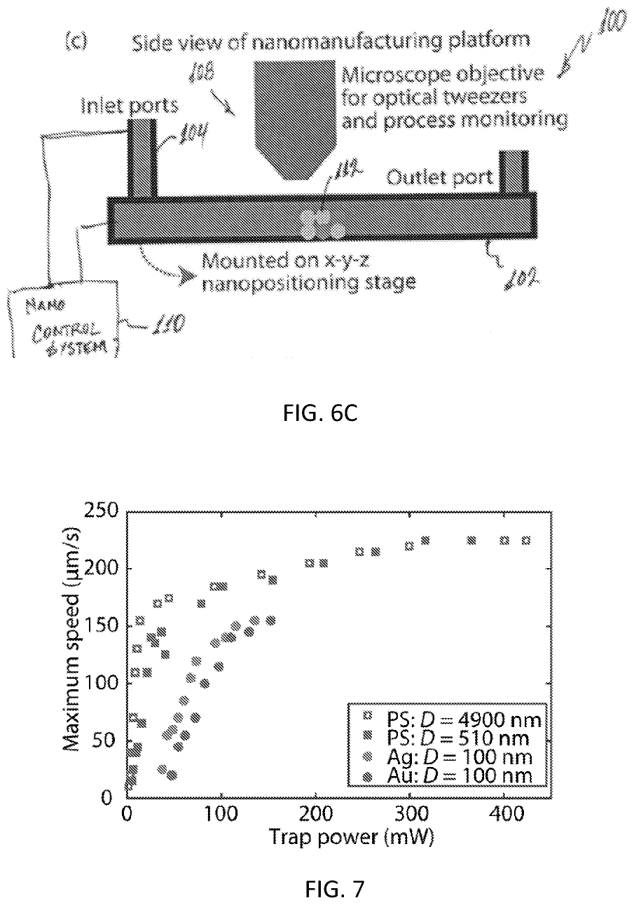

FIGS. 10A-10B shows data for gel electrophoresis analysis of particle functionalization. FIG. 10A shows different concentrations of lipoic acid—PEG—biotin were mixed with 80 nm citrate-stabilized gold nanoparticles, and run through a large pore size agarose gel. Functionalized particles exhibit a smaller travel distance. FIG. 10B shows that travel distances can be used to estimate zeta potential, using the manufacturer-specified zeta potential of the citrate-stabilized particles as a reference.

According to an embodiment, commercial citrate-stabilized gold spheres, were purchased and mixed with lipoic acid—PEG—biotin molecules. The sulfur atoms in the lipoic acid group bind strongly to the gold particles and displace citrate, while the polyethylene glycol (PEG) chain acts as a spacer, and the biotin group will be used to bind to streptavidin-functionalized nanoparticles. According to an embodiment, gel electrophoresis can be used to characterize the functionalization of these particles, as shown in FIGS. 10A-10B. The lipoic acid—PEG—biotin surface chemistry results in a less negative surface charge than citrate, as well as a slightly larger particle size, both of which result in a reduced travel distance in the gel. These results confirm that the nanoparticles are functionalized and help establish what concentrations of reagents are necessary to fully coat each nanoparticle.

According to an embodiment, the nano-assembly platform can have a central fabrication chamber filled with an aqueous solution and sandwiched between two transparent glass or polymer substrates. A region on one of these substrates can be functionalized to promote adhesion for the first layer of the manufactured structure. Pressure-driven microfluidic flow can deliver particles near the end of the inlet channels. The optical tweezer system can then drag particles from the end of their channels to the fabrication region. When the concentrations of particles near the ends of their channels become depleted, a pulse of pressure-driven flow can deliver more particles.

According to an embodiment, the positioning aspects of the nano-assembly platform can be automated in one or more phases. For example, the system can be automated according to the following:

Positioning phase 1: Semi-automatic. Each particle can be loaded into the trap manually by a human operator fishing for particles, with the stage controlled through a joystick interface. The trapped particle is then delivered to its desired location automatically using a programmed path derived from a computer-aided design (CAD) file.

Positioning phase 2: Fully automatic. A QPD can be used to determine whether there are 0, 1, or 2+ particles in the trap at any given time (see FIG. 8). The computer-controlled stage can then perform a rapid automated fishing procedure until the QPD registers a single particle in the trap. If 2+ particles fall in the trap simultaneously, the laser can turn off for a short period of time, and then the fishing procedure will repeat.

Positioning phase 3: High-throughput. The throughput can be increased by approximately two orders of magnitude using holographic optical tweezer (HOT) systems. A HOT system converts a single incident laser beam into many individual traps in parallel using a spatial light modulator. With this approach, the trapping of hundreds of particles simultaneously has been demonstrated.

For polystyrene, gold, silver, and silica, the system can be utilized to find the minimum and maximum size of spherical particles that can be stably trapped. For a variety of sizes within this range, the positioning accuracy can be quantified, as well as the maximum particle manipulation speed, which was partially measured in FIG. 7. According to an embodiment, it is expected that the system will be able to trap gold and silver nanoparticles with diameters at least as small as 18 nm, polystyrene particles smaller than 39 nm, and silica particles smaller than 49 nm based on their relative polarizabilities. The strength of the trap also affects the accuracy with which particles can be positioned. Based on calculations of the optical gradient force in the trap along with Boltzmann statistics to account for Brownian motion within the trap, positional accuracies of (r)=13 nm are estimated for a 50 nm diameter gold particle, and (r)=5 nm for a 100 nm gold particle, because (r)∝D^{-3/2}, where D is the particle diameter. Again, higher laser powers can lead to even better positional accuracies than the values quoted here. While external disturbances, vibrations, etc. can also impact positional accuracy, these effects can be mitigated using vibration-isolated optical tables and other engineering control measures.

A common misconception of optical tweezers is that sensitive objects cannot be optically trapped due to resulting laser-induced damage. Contrary to this opinion, experimental evidence has shown, for example, that living biological cells can replicate within an optical trap, and that materials with low melting points, such as polystyrene, can be easily trapped without damage to the particle. There is eventually a point where a high enough laser power can damage materials, but often this point is far more than necessary for high-precision optical trapping.

According to an embodiment, the binding chemistry can be modified according to one or more phases, although many other modifications and implementations are possible. According to one embodiment, the binding chemistry is modified according to the following:

Binding phase 1: As-received functionalized beads. In this phase, particles that are commercially available with functional coatings such as biotin or streptavidin are used. These particles will primarily be used to assess the positional capabilities of OPAL, as well as to serve as a reference standard for the ability to functionalize particles in-house.

Binding phase 2: In-house functionalization. While biotin- and streptavidin-coated particles are commercially available, the ranges of sizes and materials are limited. To generate a larger family of useable building blocks, metal, silica, and polystyrene particles can be functionalized rather than purchased. Gold and silver nanoparticles can be functionalized, for example, using a similar procedure to that in FIGS. 10A-10B. For silica nanoparticles, single functionalization can be performed in using molecules with silane groups. Such molecules were used to functionalize the glass substrate in FIG. 9D. Polymer nanoparticles can often be commercially obtained with carboxylate surfaces, which can be further functionalized through carbodiimide crosslinkers such as EDC (1-ethyl-3-(3-dimethylaminopropyl)carbodiimide hydrochloride) that can facilitate ultimate functionalization with amine-containing molecules such as streptavidin or antibodies. These functionalization approaches can also be applied to polymer structures that are constructed separately, for example, using two-photon polymerization. In this way existing structures can be augmented or decorated. These functionalization routes (lipoic acid, silanes, carboxylate-carbodiimide) can be broadly applicable to a wide range of materials of interest.

According to an embodiment, assessment metrics can include one or more of: minimum voxel (feature) size, voxel placement accuracy, fabrication speed, and/or monetary cost. The minimum trappable particle size will impose a limit on the minimum voxel size (resolution precision) of the additive manufacturing approach. According to an embodiment, resolutions of <30 nm for the OPAL process are possible. According to an embodiment, a positioning accuracy of 16 nm for 30 nm particles with a 30 W laser is possible. For building blocks >40 nm, accuracy of better than 10 nm is possible. This placement accuracy may be measured, for example, by inspecting the fabricated structures with a scanning electron microscope (SEM) and quantitatively measuring the deviations of particles from their design location. SEM inspection can also be used to assess the defect concentration in fabricated structures. In principle, defective particles (e.g. misshapen, wrong size, poor surface functionalization) could also lead to defects in the assembled structure, but it is expected that the automatic particle loading procedure should be able to automatically identify many of these situations so that such particles can be rejected before they are attached to the structure.

According to an embodiment, the fabrication speed primarily depends on two factors: the binding time required to link particles together, and the particle positioning speed. The binding time will be measured by how long two particles must be held in proximity before they are irreversibly joined. In positioning phase 2, the positioning of particles can be performed automatically. The fabrication time per voxel can be at least as long as the time involved in manipulating a particle across ˜100 μm from its source region to the fabrication zone (see FIGS. 6A-6C). For example, manipulation speeds of ˜0.2 mm/s have been achieved for a variety of different particles, which may be limited by stage vibrations (FIG. 7). The return trip time will be limited only by the maximum speed of the stage, which for one stage is ˜20 mm/s. Therefore, the current manipulation time per voxel is ˜0.5 s. With a smoother translation stage, a fabrication time shorter than 0.1 s/voxel is possible. In positioning phase 3, the use of holographic optical tweezers can further boost fabrication speed by two orders of magnitude, resulting in an ultimate target fabrication speed of 1000 voxels/s. In comparison, commercial two-photon polymerization systems offer piezo scanning speeds up to 100 μm/s and beam scanning speeds up to 10 mm/s with a feature size of ˜160 nm (lateral, vertical is approximately 3 times larger), resulting in fabrication speeds of ·10⁴ voxels/s, which is one order of magnitude larger than the proposed OPAL approach. However, OPAL offers key advantages over two-photon polymerization, which makes it worth the slightly slower speed, including significantly smaller feature sizes and the ability to build structures out of heterogeneous material components.

According to an embodiment, the systems and methods described or otherwise envisioned herein can be applied to create functional pixel superstructures on commercial image sensors for simultaneous angle and polarization sensing. Angle-sensing pixels enable plenoptic light-field imaging for 3D imaging by providing the intensity, position, and angle of light rays impinging on the sensor. While light field imagers already exist, the pixel superstructures could enable significantly smaller and lighter devices than the current state-of-the-art without sacrificing performance. Pixel superstructures can also provide additional functionalities, including polarization, wavelength, and potentially relative time-of-flight sensitivity.

To show that it is possible to fabricate small angle-sensitive pixels using metallic nanoparticle superstructures, the OPCODE approach was utilized to design optimal structures for coupling light at a 45° angle of incidence in the x-z plane. In these simulations, incident plane waves with free-space wavelength 600 nm and s-polarization were assumed. Spacings between silver particles are at least 5 nm to account for linker molecules. The background material is assumed to index-match to fused silica in these simulations.

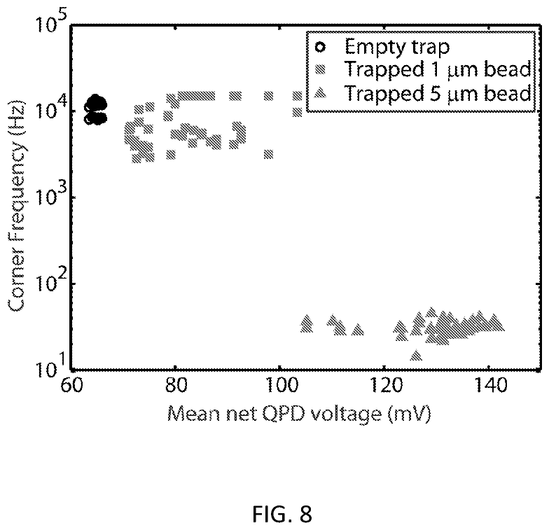

FIGS. 11A-11C shows angular sensitivity with sub-micron pixels for an example according to an embodiment of the current invention. FIG. 11A shows an OPCODE-generated structure for an angle sensitive pixel composed of 49 silver spheres of diameter 50 nm with SiO₂ background media. According to an embodiment, this structure can be supported by a scaffold that is index-matched to the background. FIG. 11B is normalized pixel sensitivity as a function of incident angle for the geometry shown in FIG. 11A. This geometry has been optimized for maximum relative sensitivity to the angle (θ, ϕ)=(45°, 0°). The pixel is 1.5 times more sensitive to light from this angle than any of the other angles tested. FIG. 11C is sensitivity of a pixel without any nanostructuring. This shows the expected COS θ dependence, with the pixel being most sensitive to light at normal incidence (θ=0°).

FIGS. 11A-11C show that it is possible to obtain angular sensitivity with small 300 nm×300 nm pixels. This is approximately one order of magnitude smaller in linear dimension than current pixels in light field imagers, which would correspond to a volumetric size and weight reduction of approximately three orders of magnitude. Currently, even conventional sensors with pixel size this small are not commercially available, largely because they provide no significant benefit over micron-scale pixels for existing consumer devices. However the potential for small and compact light field imagers could drive demand for image sensors with this smaller pixel size.

To create these angle-sensitive pixels, OPCODE was directed to minimize a cost function given by the ratio between the largest flux of light incident on the pixel active area at any angle other than the target angle to the flux of light incident on the pixel active area at the target angle. In each iteration, the sensitivity to 77 different angles of incidence were simulated (7 polar angles and 11 azimuthal angles). These correspond to the spots shown in FIG. 11B. In other words, OPCODE is directed to maximize the sensitivity to the optimization angle with respect to the other 76 angles. The structure shown in FIG. 11A can be supported by a scaffold of silica nanoparticles that are index-matched to a background media such as spin-on glass. Interestingly, this structure that was generated by OPCODE can be thought of as a combination of a curved mirror segment together with nanoantennas that act as directors, similar to the directors found in conventional Yagi-Uda antennas. For comparison, the angular sensitivity of pixels were also simulated without any superstructure, which follow the expected cos θ dependence, as shown in FIG. 11C.

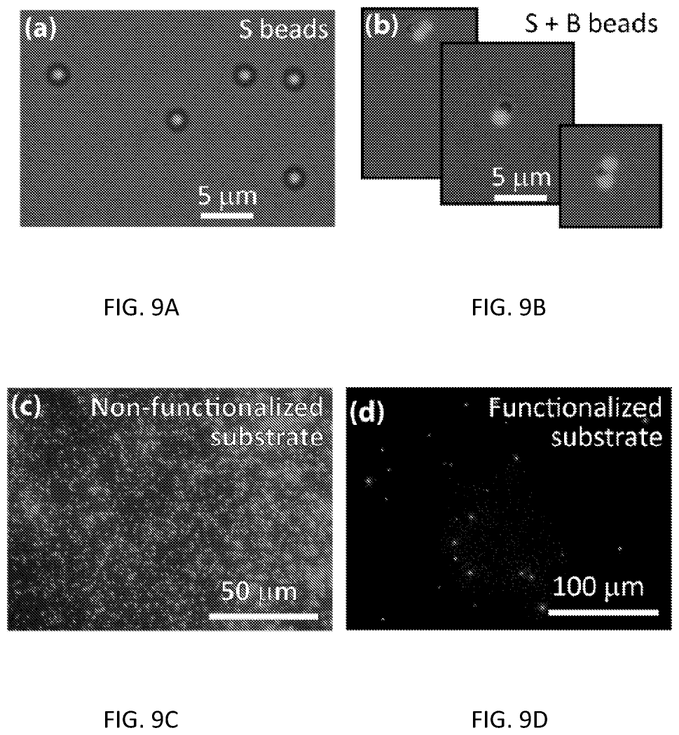

FIGS. 12A-12B show an example in which OPCODE was used to generate pixel superstructures for larger, conventional micron-scale pixels, according to an embodiment of the current invention. FIG. 12A shows an OPCODE-generated structure composed of 70 silver spheres of diameter 70 nm. This collection of spheres acts like a phased array of nanoantennas for preferential sensitivity to light incident at angle (θ,ϕ))=(45°, 0°). In practice, this structure would be supported by a scaffold that is index-matched to the background media. FIG. 12B shows normalized pixel sensitivity as a function of incident angle for the geometry shown in FIG. 12A. The pixel is 6.4 times more sensitive to light at angle (45°, 0°) than any of the other 76 angles.

The larger pixels shown in FIG. 12A more closely resemble the commercial pixels that could be used in some embodiments, but with a smaller pixel active area. Because of the larger domain, it is possible to achieve a better angular sensitivity than possible for the small pixel. In FIG. 12B, the pixel is 6.4 times more sensitive to the design angle than any of the other angles tested, whereas in FIG. 11B, the pixel was 1.5 times more sensitive to the design angle than any other angle.

According to an embodiment, the system and method may comprise different particle sizes (50-150 nm), wavelength dependence (visible—near IR), polarization dependence, material compositions (Au, Ag, SiO₂, Si, TiO₂), and background media (air, polymers). The system may also be modified to account for cross-talk between neighboring pixels. For example, blocks of pixels can be optimized simultaneously with a single superstructure that directs incident light at different angles and different polarizations to different pixels. Among other differences, some key differences between this superstructure and the microlenses that are currently used in most light-field imaging systems are its polarization sensitivity and its potential to guide light with length scales below λ/2. This capability was demonstrated in FIGS. 4A-4F, which shows sub-diffraction limit guiding of light using shielded coaxial nanoscale transmission lines.

According to an embodiment, one or more designs as described or envisioned herein can be fabricated directly on top of the image sensor using the OPAL approach, with a microfluidic chamber adapted to handle the image sensor as a substrate. For example, the system can use either image sensors that come in a bare die format, or can decap the protective glass covers that are found on most image sensors. The system may use image sensors that do not have microlenses or color filters on top of the pixels. In the event that the optical trapping beam is so powerful that it damages the image sensor, structures can be fabricated on a small piece of a glass coverslip, and then the coverslip can be flipped and it can be adhered to the image sensor with the nanostructures sandwiched in between and aligned with the appropriate pixels.

According to an embodiment, laser systems of different wavelengths can be utilized. A collimated beam can be directed toward the image sensor chip, which will be mounted on a 2-axis goniometer. The response of each pixel will be measured as a function of the angle of incidence set by the goniometer. The sensitivity to different polarizations will be measured by controlling the polarization of the incident beam using retarders. According to an embodiment, broadband incoherent light can be utilized. The light source can, for example, be placed far from the image sensor with a small aperture in front of it in order to simulate a point source in the far-field.

One embodiment is a complete compact 3D light field imaging device. The device can include, for example, an angle-sensitive image sensor and a small lens similar to that found in cell phone cameras. The system can capture light field images, and these images can be processed and reconstructed using standard approaches.

An angle-sensitive imager according to one of the systems or methods described or envisioned herein can be evaluated using the metrics of spatial resolution, angular resolution, noise level, total package size, and total package weight. The resolution and noise level metrics can be measured using standard imaging targets such as 1951 Air Force Targets and Siemens Star Targets placed at varying distances from the image sensor. For evaluation, the results can be compared to those of existing microlens-based and grating-based light field imagers.

According to an embodiment, the systems or methods described or envisioned herein can be utilized for many different applications, including but not limited to efficient out-coupling for testing photonic integrated circuits (FIGS. 3A-3D) as well as sub-diffraction limit imaging arrays (FIGS. 4A-4F) in microscopy, among many others.

According to an embodiment, another application of OPCODE and OPAL could be the assembly of nanorobotic devices. In nanorobotics applications, the static biochemical linkages described herein could be replaced with molecular linkages that undergo conformational changes when exposed to light, heat, stress, or other external stimuli. These conformational changes can be used as robotic actuators to drive motion of the nano-assembly.

According to an embodiment, another application of OPAL could be nano-biosensing. For example, many state-of-the-art biosensors have specific active regions of the sensor, and it is necessary to place appropriate functionalized chemical or photonic elements at these active regions for the sensor to be successful. For example, an optical tweezer system could be used to deposit functionalized microparticles in microfluidic chambers. These microparticles bind together in the presence of a target analyte, and can be directly imaged to determine the concentration and presence of that analyte. A simplified version of the optical tweezer system used in OPAL can be used to help fabricate these biosensors. Additionally, the system and method could encompass optical microresonator biosensors. These biosensors can be enhanced through the incorporation of nanostructures, and the OPAL approach could be used to position these nanostructures on the surface of the microresonators. The system could also be used for on-chip lens-free holographic imaging for microscopy applications by improving the resolution and sensitivity of the technique.

According to an embodiment, the systems or methods described or envisioned herein can be utilized within the broader photonics and nanomanufacturing communities. The methods and systems can provide a way to more rapidly design photonic nanostructures for use with a variety of fabrication methods other than OPAL, including various forms of self-assembly. Beyond photonics applications, three-dimensional (3D) nanomanufacturing approaches like OPAL have the potential to revolutionize future research in fields as diverse as microbiology, nanofluidics, nanorobotics, and nanoelectronics. OPAL can also be combined with other nanofabrication approaches like two-photon polymerization or lithography to decorate larger structures with heterogeneous material elements. Together, the OPCODE and OPAL approaches according to some embodiments of the current invention can enable the fabrication of devices that are currently unmanufacturable.

According to an embodiment, image sensors with pixel-level photonic nanostructures designed by OPCODE and prototyped using OPAL can improve the ability to detect, classify/identify, and localize/geolocate air, sea-surface, and ground targets, for example. For example, the light-field and polarization sensitivity described or envisioned herein can help to image through a degraded visual environment (clouds, dust, fog, rain). The ability to achieve these goals with a compact and light weight device would be a strong asset in military applications where size, weight, and power (SWaP) are always a concern.

According to an embodiment, the systems or methods described or envisioned herein can be applied to electromagnetic scattering problems at larger scales to design equipment that exhibits particular scattering signatures in millimeter or radio wavelengths. OPCODE could also be applied to inverse scattering problems, where the goal is to determine the structure that generated an observed scattering signature, rather than designing a structure that generates a desired scattering signature. This could be helpful in identifying unknown targets based on their scattering signatures. OPAL can provide its own benefits through its ability to assemble devices in small batches at relatively low cost on an as-needed basis. No re-tooling is required for each new design. OPAL can also be used to modify or repair existing materials or devices. In contrast, current nanofabrication approaches either require major capital equipment that costs several hundreds of thousands of dollars to millions of dollars (e.g., electron beam lithography, focused ion beam milling, two photon polymerization), or require the fabrication of devices in mass quantities in order to be cost-effective (e.g., nanoimprint lithography).

### Fundamental Limits of Optical Tweezer Nanoparticle Manipulation Speeds

Optical tweezers are a non-contact method of 3D positioning applicable to the fields of micro- and nano-manipulation and assembly, among others. In these applications, the ability to manipulate particles over relatively long distances at high speed is essential in determining overall process efficiency and throughput. In order to maximize manipulation speeds, it is necessary to increase the trapping laser power, which is often accompanied by undesirable heating effects due to material absorption. As such, the majority of previous studies focus primarily on trapping large dielectric microspheres using slow movement speeds at low laser powers, over relatively short translation distances. In contrast, we push nanoparticle manipulation beyond the region in which maximum lateral movement speed is linearly proportional to laser power, and investigate the fundamental limits imposed by material absorption, thus quantifying maximum possible speeds attainable with optical tweezers. We find that gold and silver nanospheres of diameter 100 nm are limited to manipulation speeds of ˜0.15 mm/s, while polystyrene spheres of diameter 160 nm can reach speeds up to ˜0.17 mm/s, over distances ranging from 0.1 to 1 mm. When the laser power is increased beyond the values used for these maximum manipulation speeds, the nanoparticles are no longer stably trapped in 3D due to weak confinement as a result of material absorption, heating, microbubble formation, and enhanced Brownian motion. We compare this result to our theoretical model, incorporating optical forces in the Rayleigh regime, Stokes' drag, and absorption effects, and find good agreement. These results show that optical tweezers can be fast enough to compete with other common serial rapid prototyping and nanofabrication approaches.

The ability to optically trap small objects was first proposed by Ashkin in 1970.¹ In the decades since, optical tweezers (OT) have been used for the precise measurement of small forces and displacements, especially in the measurement of the mechanical properties of biological molecules.²⁻⁴ OT are a non-contact manipulation technique that provide 3D nano-positioning of arbitrary objects and have widespread applicability to micro- and nano-fabrication and assembly⁵⁻¹⁶ and fields requiring biological compatibility such as cell sorting,¹⁷⁻¹⁹ tissue engineering,²⁰⁻²² and the study of cell-organism interactions.²³ In general, these applications of OT require much larger manipulation distances and forces than traditionally used in the measurement of mechanical properties of biological molecules, and significant effort has been devoted to improving the throughput of these techniques.

In previous studies, OT throughput has been improved by trapping multiple beads in parallel, accomplished using either a time-sharing or multiplexing approach, e.g. holographic optical tweezers. In the case of time-sharing, scanning galvanometric mirrors can be used to quickly move the beam from one trap location to the next, returning to each location within reasonably short intervals such as to prohibit objects from escaping from the transient trap.^{24,25} Multiplexing, on the other hand, uses a diffractive optical element to split the beam into multiple traps of reduced power.²⁶⁻³² While throughput is improved in both of these techniques, translation distances are limited by the microscope objective field of view, and the time-averaged optical power in each trap suffers, thus reducing maximum possible manipulation speeds.

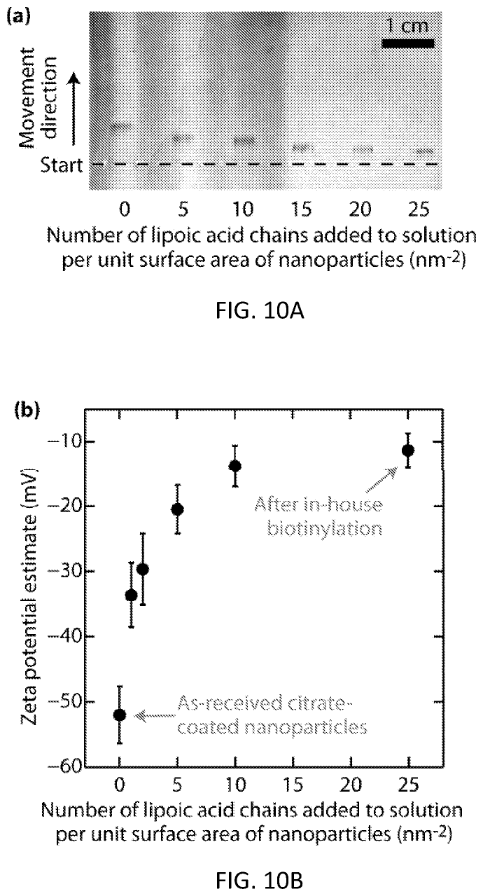

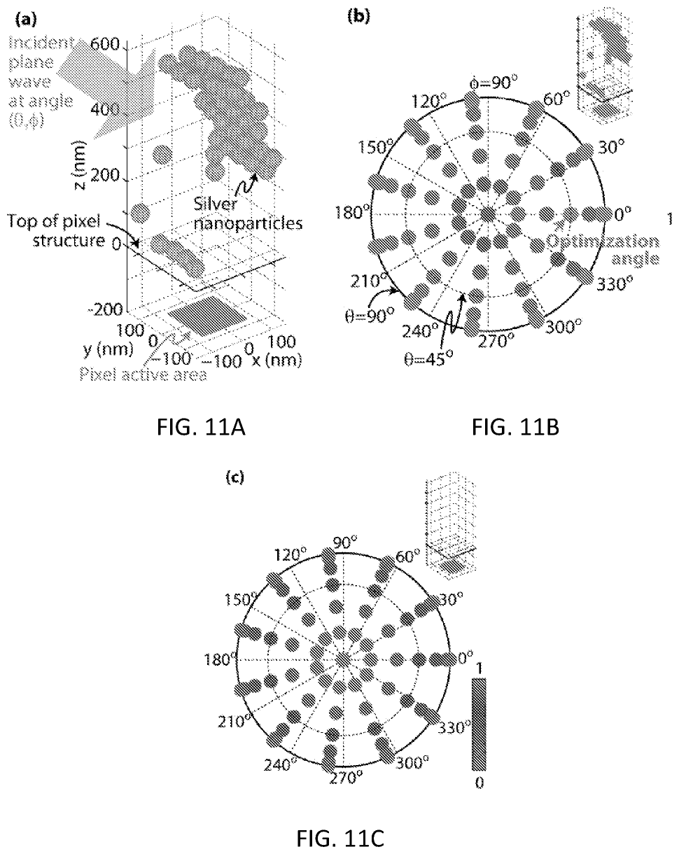

While the creation of multiple simultaneous traps is one approach for improving throughput, we instead investigate here the fundamental limits on manipulation speeds in single-trap situations. These results can then also be applied to multiple trapping systems. Former studies exploring optimization of trapping speeds generally use sinusoidal motion over short distances, emphasize the linear regime (in which power and maximum velocity are linearly proportional to each other), and use relatively large particles of dielectric materials ranging between 1 and 6 microns in diameter.^{27,28,33-35} In contrast, we test the manipulation speeds of a large range of particle sizes (100 nm to 5 μm) including metals and dielectrics over long travel distances (0.1 mm to 1 mm) (FIGS. 13A-13B), extending to laser powers beyond the conventionally expected linear relationship between power and manipulation velocity. In the nanoscale regime in particular, we find that manipulation speeds are fundamentally limited by material absorption and heating. While absorption and heating are consistently encountered in studies involving the optical trapping of metal nanoparticles,³⁶⁻⁴¹ previous studies do not apply their models to theoretically predict minimum trapping powers for particles of different materials or sizes. Here we provide theoretical values for both minimum and maximum trapping powers for gold, silver, and polystyrene nanoparticles based on optical trap well depth calculations as a function of particle size and trap power, accounting for heating effects. Furthermore, to the best of our knowledge, we achieve the fastest recorded optical tweezer manipulation speed for submicron particles of 0.17 mm/s.

### Results and Discussion

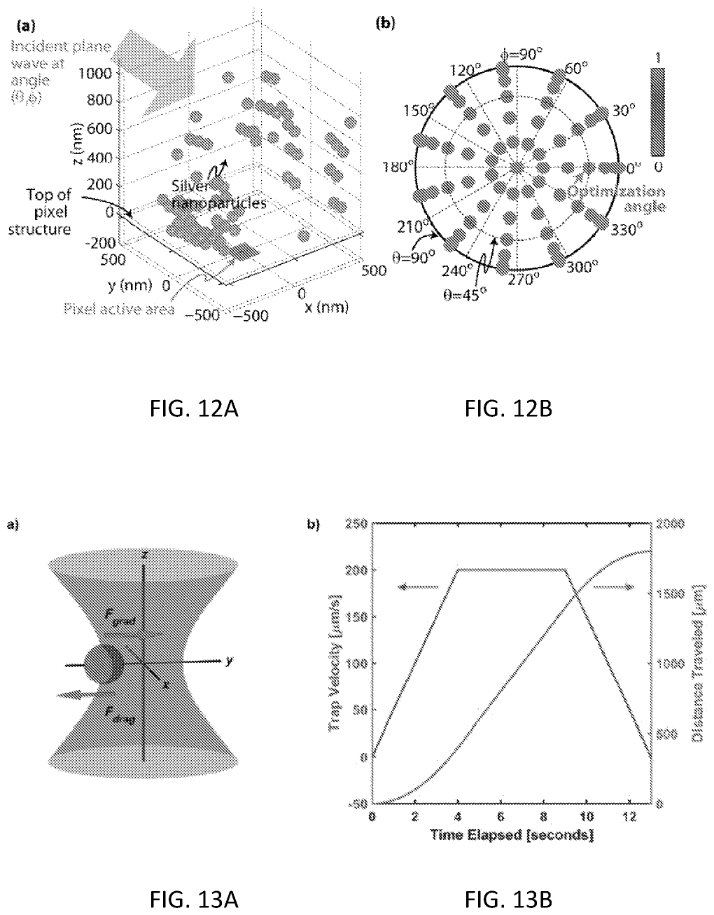

The results of the maximum particle manipulation speed as a function of laser power are summarized in FIG. 14. For the polystyrene beads, the maximum manipulation speed is 0.22 mm/s, while the maximum speed for the metallic beads is around 0.15 mm/s. The maximum manipulation speed of the polystyrene microspheres is limited in our experimental setup by the onset of vibrations of our particular translation stage at speeds >0.22 mm/s, as evidenced by audible mechanical slipping noises during the experiments that only occur at speeds above this threshold. Although mechanical slippage is not distinctly audible at slower speeds, subtle increases in vibration are observed beginning at 0.15 mm/s, indicated by the discontinuity in speed versus power data for the microspheres. In contrast to the mechanical limitations of the system that bound maximum microsphere manipulation speeds, we find that the maximum metallic and polystyrene nanosphere manipulation speeds are slower than for the microspheres, a result we attribute to the fundamental material absorption and heating. Once the metallic nanoparticles are exposed to laser powers greater than ˜150 mW (˜170 mW for dielectric nanoparticles), the optical trap is no longer able to contain the particles for significant lengths of time—even in static traps—primarily due to the formation of microbubbles of water vapor. Therefore, the trapping speed corresponding to this laser power serves as the maximum attainable movement speed in aqueous solutions for the metallic and dielectric beads of this particular size for our wavelength of trapping laser.

Before discussing the absorption-limited trapping speeds in more detail, we first confirm that our results are consistent at low trap powers with the conventional optical trapping theory. In the absence of external factors, we expect the maximum manipulation speed to increase linearly with the laser power of the optical trap.^{33,34} In practice, this is best observed in the low power regime in which thermal and absorption effects have minimal significance.

In a dynamic trapping situation in the low power regime, the maximum trapping speed for a given particle is determined by balancing the optical forces induced by the trapping beam and the frictional (drag) forces felt by the particle as it moves through the surrounding medium (FIG. 13A). Due to the relatively small sizes and speeds of the particles (Reynolds number Re≈10⁻⁻⁷), we can assume that we are operating in the laminar flow regime, and thus the frictional forces on the particle can be modeled using Stokes' law, simply expressed as:

F_{drag}=6πηav [1]

where η is the dynamic viscosity of the surrounding medium (for water, η=0.89 mPa·s), a is the radius of the particle, and v is the velocity at which the particle is traveling. As long as the particle is not within close proximity to a surface, as was ensured during the experiment (see: Methods), this equation accurately predicts frictional forces. The optical forces, on the other hand, require more involved numerical calculation through various possible methods, depending upon the size of the particle with respect to the trapping beam wavelength.

For the case of very small particles (a<<λ), the particle can be treated as a dipole in the Rayleigh approximation. In this regime, we calculate the time-averaged force on the particle using the following expression:

$$〈 \vec{F} 〉 = {ɛ}_{b} \frac{{α}^{′}}{2} {\sum }_{i} Re \{ {E}_{i}^{*} ∇ {E}_{i} \} + {ɛ}_{b} \frac{{α}^{″}}{2} {\sum }_{i} Im \{ {E}_{i}^{*} ∇ {E}_{i} \} \qquad [ 2 ]$$

where α=α′+iα″ is the complex polarizability of the trapped particle, ε_{b} is the permittivity of the background medium (i.e. water), and Eᵢ (Eᵢ*) is the component of the complex (conjugate) electric field along cardinal direction i.⁴² The electric field is calculated using the theory of strongly focused beams popularized by Richards and Wolf.⁴³ In the dipole limit, it is imperative to account for the interaction between the dipole's radiation and its motion and accordingly the polarizability is defined as:

$$α = {{α}_{CM} [ 1 - \frac{{ik}^{3}}{6 {πɛ}_{0}} {α}_{CM} ]}^{- 1} \qquad [ 3 ]$$

where α_{CM}is the polarizability obtained from the Clausius-Mossotti relation, k is the free-space wavevector, and ε₀ is the free-space permittivity.⁴² Further, the Clausius-Mossotti relation states:

$${α}_{CM} = 3 {ɛ}_{0} {V}_{eff} \frac{ɛ - {ɛ}_{b}}{ɛ + 2 {ɛ}_{b}} \qquad [ 4 ]$$

where ε is the permittivity of the trapped particle and V_{eff} is the effective volume of the particle taking into account skin depth considerations,³⁸ which can be significant for metal nanoparticles. Typically, the first term in Equation 2 is referred to as the gradient force and is responsible for pulling the particle toward the trap center, while the second term is denoted the scattering force and tends to the push the particle out of the trap. Although the gradient force is prevalent along all directions, the scattering force primarily acts along the optical axis.

In the case of particles that are comparable in size to or greater than the wavelength (α˜λ or α>λ), it is no longer appropriate to apply the Rayleigh approximation. Instead, the full-wave scattering problem can be solved using the more rigorous T-matrix method. Here, we used the MATLAB toolbox developed by Nieminen et al.⁴⁴ to calculate the optical forces associated with particles that fall outside of the Rayleigh regime.

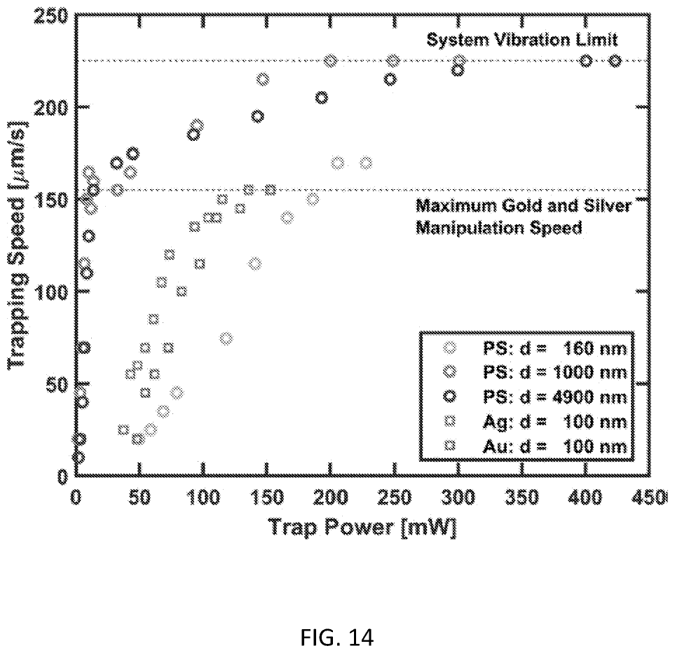

The expected behavior of the manipulation speed data can easily be assessed in the linear low-power regime, where the balance of optical forces (Equation 2) and frictional forces (Equation 1) yields a predicted maximum particle velocity. FIG. 15A shows how the optical force exerted on a particle varies as it is displaced laterally from the trap center. The local extrema of the force curves are of particular importance, as the forces at these positions are indicative of the magnitude of the opposing frictional force required to entirely remove the particle from the optical trap. FIG. 15B shows the escape forces as a function of particle size for a polystyrene (n_{PS}=1.59×0.001i)⁴⁵ sphere with a trapping beam wavelength of λ=1064 nm, assuming constant laser power of 100 mW. Curves are calculated using both the Rayleigh approximation (accurate for small particles) and the T-matrix method (accurate for all particle sizes). From a ray-optics perspective, it is intuitive to expect that the escape forces will increase with increasing particle size, as a larger size implies additional rays from the focused beam refracting at the particle surface, and hence a greater change in momentum contributing to a stronger optical trap. Using this same reasoning, we would expect a tapering off in escape force beyond the point at which the particle size surpasses the diffraction-limited beam spot at the focus, i.e. λ/(2 NA). This behavior is readily seen in the theoretically produced curve.

Trapping forces can also be influenced by other system parameters, such as objective numerical aperture and beam filling factor. While it is commonly understood that slightly underfilling the trapping objective is the ideal case and maximizes lateral forces,⁴⁶ we provide specific details about the effects of numerical aperture on trapping in FIG. 15C and FIG. 15D. In the nanoparticle regime, we expect monotonically increasing trapping force as we increase NA, due to the corresponding decreases in focal spot size, and thus enhancement in the electric field gradient. Specifically, we find that for polystyrene nanoparticles (2a=100 nm), each 0.1 incremental increase in NA leads to ˜30% improvement in trapping force, and by extension, trapping speed. In the microparticle regime, however, the behavior between NA and trapping force becomes more convoluted due to the larger volume of interaction between the field and the object. We find that optimal trapping NA for microspheres actually decreases with increasing particle size, in contrast to the enhancement seen in the Rayleigh regime. Similar results were determined when investigating the ideal filling factor, which in turn can be used to define an effective numerical aperture for the system.⁴⁶

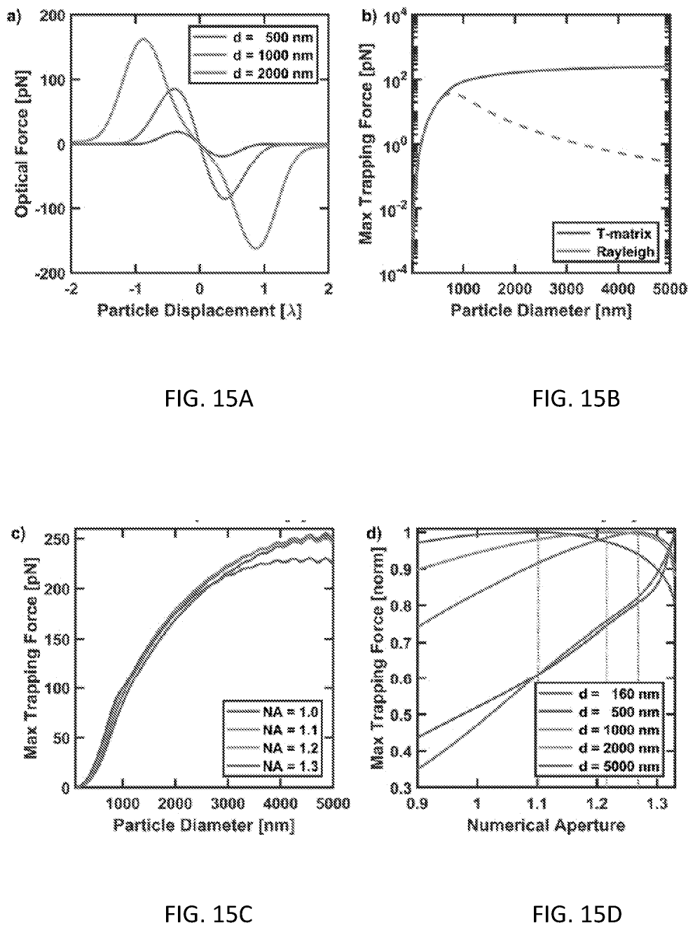

FIG. 16A shows the experimental maximum trapping speeds of polystyrene microspheres of various sizes in the linear regime along with linear fits, and FIG. 16B shows the maximum speeds of polystyrene, gold, and silver nanospheres. This linear relationship agrees with the theoretical model. Looking closer at Equation 2, we note that the expression under summation in the gradient (first) term is essentially the gradient of the beam irradiance, which is directly proportional to the laser power. Hence, maximum trapping force and maximum trapping velocity (from Equation 1) both scale linearly with the laser power. It is therefore convenient to use the power-normalized velocity (vₘₐₓ/P) to compare the trapping efficiency of various particles. This quantity is equivalent to the slope of our experimental speed versus power data contained in FIGS. 16A and 16B.

In predicting the theoretical power-normalized particle velocity, we can immediately see that Stokes' law contributes an a⁻¹ dependence when solving for v. However, we must also take into account the particle size dependence inherent in the optical force calculation. In the Rayleigh regime, we expect the optical force to increase with the volume of the particle (∝a³) due to the volumetric dependence in the polarizability (Equation 4). As reasoned earlier, we do not expect much change in the optical force acting on particles larger than the diffraction-limited spot size, as the particle is already interacting with the entire beam at this limit. Explicitly, we can express the power-normalized velocity scaling with particle size as:

$$( {v}_{max} / P ) ∼ \{ \begin{matrix}{a}^{2} & a < λ / 2 \\ {a}^{- 1} & a > λ / 2\end{matrix} \qquad [ 5 ]$$

A general implication of this formulation is the presence of an ideal particle size of 2a≈λ for dielectrics at which the power-normalized velocity reaches the maximum attainable value for a specific material. This is investigated in FIG. 16C, which compares the slopes of the experimental data to theoretical predictions obtained by balancing the optical and drag forces. In the theoretical curve for polystyrene spheres, the maximum occurs around 2a=1200 nm, which is roughly of order λ. Note that Equation 5 is only a rough approximation and we do not expect the peak to occur exactly at λ. Also note that this theoretical curve in FIG. 16C uses the overall beam power as a fitting parameter, which accounts for any losses in the optical system. There is a factor of 4.2 (95% confidence interval [2.7, 5.7]) difference between the optical power fitted from power-normalized velocity results, assuming a perfect Gaussian beam shape in the focal plane versus the power we experimentally measured directly after the microscope objective. We expect some differences in these two values for a variety of reasons, including optical system misalignment, thermal effects, laser power fluctuations, deviation of the laser beam from a perfect Gaussian profile, and deviation of particles from the ideal shape or size.

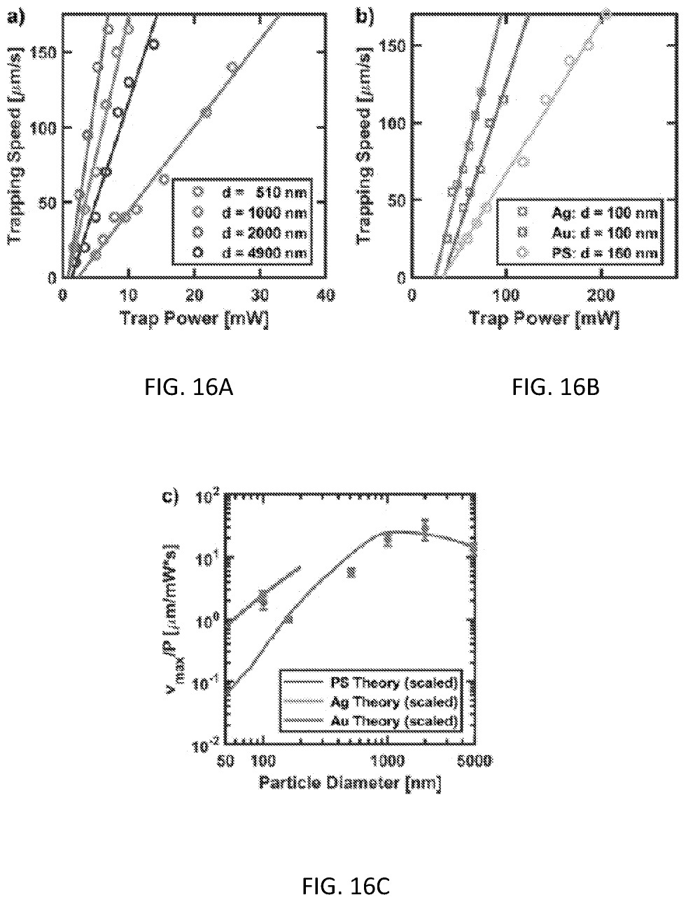

One clear distinction between the micro-scale and nano-scale particles is the minimum power required for stable optical trapping, as can be seen in FIG. 14 and FIGS. 16A and 16B. While the polystyrene microparticles trap stably at powers as low as ˜2 mW, the metallic and polystyrene nanoparticles require powers >35 mW to trap successfully, even with a stationary trap. As the trapping force scales with a³ for sub-diffraction sized particles, this result is not surprising. In terms of material differences, in the Rayleigh regime, we expect a larger polarizability for the metallic particles, and numerically find an approximately 6-fold theoretical trapping enhancement for metals, when compared to polystyrene particles of the same size. This explains why we experimentally find larger power-normalized velocities for the metal nanoparticles (2a=100 nm) than for the dielectric nanoparticles, despite their larger size (2a=160 nm), as shown in FIGS. 16B and 16C. These results can be compared to our theoretical predictions, which are shown in FIGS. 17A-17D. These figures show the minimum required power for stable axial trapping, which is weaker than for the transverse directions due to the optical scattering force. Here we assume traps become unstable for well depths less than ˜10k_{BT}. Our calculations for gold and silver indicate minimum trapping powers of ˜20 mW for the 100 nm particles as shown in FIG. 17D, which are in agreement with the experimental intercepts seen in FIG. 16B. In the case of the polystyrene nanoparticles (2a=160 nm), we calculate a minimum trapping power of ˜20 mW. Accordingly, the intercept of our speed versus power data (FIG. 16B) agrees well with the expected lower limit.

Finally, we analyze the thermal effects which occur at higher trap powers. The particles are heated through laser absorption and cooled through conduction to the surrounding water. Due to the small particle size, the Peclet and Nusselt numbers are small and therefore advective cooling due to the liquid flow is insignificant, despite the relatively high velocities (see Methods section for details on our thermal model).⁴⁷ Particle heating can lead to two destabilizing mechanisms: microbubble formation due to water vaporization, and an increased characteristic thermal energy (k_{B}T) that enhances Brownian motion. We find that the first mechanism, water vaporization, is dominant. This is because the optical well depth increases quickly with laser power, overcoming any instability that can arise from enhanced thermal motion. In FIGS. 17A-17D, we see that the particle surface reaches the water vaporization temperature at laser powers of approximately 300 mW, 500 mW, and 600 mW for the 100 nm gold, 100 nm silver, and 160 nm polystyrene particles, respectively. In these cases, we infer the formation of microbubbles as the water in contact with the particle can undergo a phase transition to a gaseous state, leading to localized regions of superheating and reduced trap stability. In practice, we lose trapping stability for both types of metal nanoparticles at powers close to 150 mW, which is 2-3 times lower than theoretically predicted. In the case of polystyrene nanoparticles (2a=160 nm), the experimental upper limit on trapping has an approximately 2.5-fold discrepancy from the predicted value. We attribute these differences in theory and experiment to a combination of several effects, including: particle size variation, localized heating effects due to impurities or particle surface roughness, and deviation between chosen bulk complex refractive indices (which can vary significantly depending on the literature source) in our calculations and the true values for our nanoparticles.

To evaluate the potential effect of the second thermal destabilizing mechanism, increased Brownian motion, we have used a Kramer's escape problem approach. This model provides the predicted maximum velocities as a function of laser power. The model is more complex than the simple force balance approach described above for low laser powers, but it accounts for the destabilizing effects of Brownian motion. Using both models, we find excellent agreement between this stochastic model and the force balance method at low laser powers using the same empirical fitting factor, indicating that the destabilizing effects of Brownian motion are minimal. Furthermore, enhanced Brownian motion in the model cannot explain the nonlinear relationship between laser power and maximum manipulation velocity observed at high laser powers in FIG. 14.

### Conclusions

In summary, we demonstrate the fastest recorded manipulation speeds using optical tweezers in water for both dielectric and metallic nanoparticles, reaching 170 μm/s and 150 μm/s, respectively. In the low-power regime, we provide theoretical calculation and discussion that agrees well with our experimental trapping speed results for all particle materials and sizes. At higher powers, we push metallic and dielectric nanoparticle manipulation to the fundamental limits imposed by particle absorption and laser-induced heating, which causes saturation in our speed versus power data near the onset of this destabilizing phenomenon. Ultimately, we show that optical tweezers have the potential to provide the throughput necessary for nano-assembly approaches that can compete with existing fabrication technologies, with further advantages of material non-specificity and biological compatibility.

### Methods

Experimental Trapping Setup:

Optical manipulation speeds were measured for a variety of materials and particle sizes, which included 100 nm particles of gold and silver (NanoComposix, NanoXact) and the following sizes of polystyrene spheres: 500 nm (Bangs Laboratories, CFDG003), 1000 nm (Bangs Laboratories, CP01004), 2000 nm (Bangs Laboratories, PS05001), and 5000 nm (Magsphere, PS005UM). The optical trap was formed using a 30 Watt Nd:YAG fiber laser (Spectra-Physics, VGEN-C-30) operating at λ=1.064 μm and near-infrared transmissive 100×/NA1.1 water-immersion objective (Nikon, MRL07920). Through fitting our input beam with a Gaussian profile, we determine a 1/e² beam diameter of 4.16 mm, corresponding to a filling factor of 0.95. Optical trap power was measured by picking off the laser power before the focusing objective using a 90R/10T beamsplitter plate (ThorLabs BSX11) and photodiode sensor (ThorLabs, S121C). Experimentally, we found the power after the objective to be approximately 143× the picked-off power, implying an overall ˜16.3% transmission through the entire system. The translational movement was achieved using a 3-axis piezo-actuated stage with 200 mm range and nanometer precision (SmarAct, SLC-1740). Trapping stability was visually assessed using a CMOS camera (IDS, UI-3480LE-M-GL) set up conjugate to the trapping plane. For the larger polystyrene microspheres, we used white light illumination to image our sample. In the case of the smaller metal and dielectric nanospheres, the white light source does not provide the necessary signal to noise ratio to image the beads, so we use a darkfield imaging scheme in which a 633 nm HeNe laser (Melles Griot, 25-LHR-151-249) illuminates the sample at grazing incidence and the scattered field from the particles is detected on the image sensor. The laser, stage, and camera were controlled using a proprietary LabVIEW Visual Interface.

Samples were prepared on glass microscope slides using a piece of double-sided tape (60 μm thickness) with a rectangular hole cut out. We pipette ˜3 μL of aqueous bead solution in the center of the chamber defined by the tape cut out, place a No. 000 cover glass (Matsunami) on top, and seal with clear nail polish to minimize the rate of evaporation through the tape. In this way, we reduce any lateral shear forces experienced by the sample due to movement of the stage relative to the objective. During experimentation, trapping speed tests were executed with the bead 30 μm above the glass substrate, placing it at the middle of the sample chamber. While we have not considered proximity effects of the surface on the beads' lateral movement in the chamber (Faxen's Law), we note that for the largest particle diameter of 5 μm, we only expect an approximately 9% increase in drag force felt by the particle due to the substrate. ⁴⁸ This reduction in drag force will become even less significant with smaller bead sizes.

Trapping speed was measured as a function of laser power for the various beads by finding the maximum speed for each laser power for which the bead was contained in the optical trap in at least 80% of trials, for a minimum of 5 trials. For the polystyrene beads, the movement distance at this peak velocity was 1 mm. For the metallic beads, which are inherently more challenging to trap at lower powers due to heating effects, this distance was reduced to 0.1 mm. All of the trapping experiments were performed for lateral movements parallel to the beam polarization direction, as a linearly polarized trapping beam induces different optical forces along the respective parallel and perpendicular axes, typically resulting in an approximately 20% improvement in trapping orthogonal to the polarization direction.

Material Heating Analysis:

In steady-state, the increase in particle temperature relative to room temperature can be written as,

$$Δ T = \frac{Q}{hA} \qquad \# [ 6 ]$$

where Q is the rate of heat absorption by the particle, h is the heat transfer coefficient from the particle to the surrounding medium, and A is the particle surface area. The Nusselt number characterizes the relative magnitude of convective heat transfer to conductive heat transfer, and is given by,

$$Nu = \frac{{hR}_{part}}{κ} \qquad \# [ 7 ]$$

where Rₚₐᵣₜ is the particle radius and k is the thermal conductivity of the surrounding medium. The Peclet number characterizes the relative magnitude of advective heat transfer to conductive heat transfer, and is given by,

$$Pe = \frac{{R}_{part} v ρ {c}_{p}}{κ} \qquad \# [ 8 ]$$

where v is the relative fluid velocity, ρ is the fluid density, and cₚ is the heat capacity of the fluid. For our parameters, Pe≤10⁻⁴. For Pe<<1 Nu≈1+Pe/2≈1.47 Therefore, the rate of heat transfer from the particle to the surrounding fluid is dominated by conduction and the advective contribution is negligible. Combining Equations [6] and [7] with Nu=1, A=4πRₚₐᵣₜ², and Q=I σ_{abs},

$${T}_{part} = {T}_{∞} + I \frac{{σ}_{abs}}{4 π {R}_{part} κ} \qquad \# [ 9 ]$$

where T_{∞} is the temperature of the surrounding medium away from the particle, I is the irradiance of the laser beam incident on the particle, and σ_{abs} is the absorption cross-section of the particle.⁴⁰ The absorption cross-section is further defined as:

$${σ}_{abs} = \frac{k {n}_{water}}{{ɛ}_{0}} Im \{ {α}_{CM} \} \qquad \# [ 10 ]$$

where k is the free space wavenumber, ε₀ is the free space permittivity, and n_{water} is the refractive index of the surrounding water. In the investigation of material heating, it is frequently of interest to calculate optical well depth for comparison to the thermal limit of 10k_{B}T. This is accomplished by integrating over the total force curve along a specified dimension and measuring the depth of the resulting potential well. The expected time of retaining the particle is characterized in the Supporting Info using a Kramer's escape time approach.

### REFERENCES

(1) Ashkin, A. Acceleration and Trapping of Particles by Radiation Pressure. Phys. Rev. Lett. 1970, 24, 156-159.
(2) Wang, M. D.; Yin, H.; Landick, R.; Gelles, J.; Block, S. M. Stretching DNA with Optical Tweezers. Biophys. 1 1997, 72, 1335-1346.
(3) Moffitt, J. R.; Chemla, Y. R.; Smith, S. B.; Bustamante, C. Recent Advances in Optical Tweezers. Annu. Rev. Biochem. 2008, 77, 205-228.
(4) Svoboda, K.; Block, S. M. Optical Trapping of Metallic Rayleigh Particles. Opt. Lett. 1994, 19, 930-932.
(5) Grier, D. G. A Revolution in Optical Manipulation. Nature 2003, 424, 810-816.
(6) Maragò, O. M.; Jones, P. H.; Gucciardi, P. G.; Volpe, G.; Ferrari, A. C. Optical Trapping and Manipulation of Nanostructures. Nat. Nanotechnol. 2013, 8, 807-819.
(7) Čižmár, T.; Romero, L. C. D.; Dholakia, K.; Andrews, D. L. Multiple Optical Trapping and Binding: New Routes to Self-Assembly. J. Phys. B: At. Mol. Opt. Phys. 2010, 43, 102001.
(8) Agarwal, R.; Ladavac, K.; Roichman, Y.; Yu, G.; Lieber, C. M.; Grier, D. G. Manipulation and Assembly of Nanowires with Holographic Optical Traps. Opt. Express 2005, 1 3,8906-8912.
(9) Benito, D. C.; Carberry, D. M.; Simpson, S. H.; Gibson, G. M.; Padgett, M. J.; Rarity, J. G.; Miles, M. J.; Hanna, S. Constructing 3D Crystal Templates for Photonic Band Gap Materials Using Holographic Optical Tweezers. Opt. Express 2008, 16, 13005-13015.
(10) Bergman, J.; Osunbayo, O.; Vershinin, M. Constructing 3D Microtubule Networks Using Holographic Optical Trapping. Sci. Rep. 2016, 5.
(11) Castelino, K.; Satyanarayana, S.; Sitti, M. Manufacturing of Two and Three-Dimensional Micro/Nanostructures by Integrating Optical Tweezers with Chemical Assembly. Robotica 2005, 23, 435-439.
(12) Ghadiri, R.; Weigel, T.; Esen, C.; Ostendorf, A. Microassembly of Complex and Three-Dimensional Microstructures Using Holographic Optical Tweezers. J. Micromech. Microeng. 2012, 22, 065016.
(13) Gould, O. E. C.; Qiu, H.; Lunn, D. J.; Rowden, J.; Harniman, R. L.; Hudson, Z. M.; Winnik, M. A.; Miles, M. J.; Manners, I. Transformation and Patterning of Supermicelles Using Dynamic Holographic Assembly. Nat. Commun. 2015, 6, 10009.
(14) Kim, J.-D.; Lee, Y.-G. Construction and Actuation of a Microscopic Gear Assembly Formed Using Optical Tweezers. J. Micromech. Microeng. 2013, 23, 065010.
(15) Terray, A.; Oakey, J.; Marr, D. W. M. Fabrication of Linear Colloidal Structures for Microfluidic Applications. Appl. Phys. Lett. 2002, 81, 1555-1557.
(16) Park, I.-Y.; Sung, S.-Y.; Lee, J.-H.; Lee, Y.-G. Manufacturing Micro-Scale Structures by an Optical Tweezers System Controlled by Five Finger Tips. J. Micromech. Microeng. 2007, 17, N82-N89.
(17) Applegate, R. W.; Squier, J.; Vestad, T.; Oakey, J.; Marr, D. W. Optical Trapping, Manipulation, and Sorting of Cells and Colloids in Microfluidic Systems with Diode Laser Bars. Opt. Express 2004, 12, 4390-4398.
(18) Grover, S. C.; Skirtach, A. G.; Gauthier, R. C.; Grover, C. P. Automated Single-Cell Sorting System Based on Optical Trapping. J. Biomed. Opt. 2001, 6, 14-22.
(19) Wang, X.; Chen, S.; Kong, M.; Wang, Z.; Costa, K. D.; Li, R. A.; Sun, D. Enhanced Cell Sorting and Manipulation with Combined Optical Tweezer and Microfluidic Chip Technologies. Lab. Chip 2011, 11, 3656.
(20) Mirsaidov, U.; Scrimgeour, J.; Timp, W.; Beck, K.; Mir, M.; Matsudaira, P.; Timp, G. Live Cell Lithography: Using Optical Tweezers to Create Synthetic Tissue. Lab. Chip 2008, 8, 2174.
(21) Kirkham, G. R.; Britchford, E.; Upton, T.; Ware, J.; Gibson, G. M.; Devaud, Y.; Ehrbar, M.; Padgett, M.; Allen, S.; Buttery, L. D.; Shakesheff, K. Precision Assembly of Complex Cellular Microenvironments Using Holographic Optical Tweezers. Sci. Rep. 2015, 5.
(22) Zhang, H.; Liu, K.-K. Optical Tweezers for Single Cells. J. R. Soc., Interface 2008, 5, 671-690.
(23) Rouger, V.; Bordet, G.; Couillault, C.; Monneret, S.; Mailfert, S.; Ewbank, J. J.; Pujol, N.; Marguet, D. Independent Synchronized Control and Visualization of Interactions between Living Cells and Organisms. Biophys. J. 2014, 106, 2096-2104.
(24) Mio, C.; Gong, T.; Terray, A.; Marr, D. W. M. Design of a Scanning Laser Optical Trap for Multiparticle Manipulation. Rev. Sci. Instrum. 2000, 71, 2196-2200.
(25) Visscher, K.; Brakenhoff, G. J.; Krol, J. J. Micromanipulation By “Multiple” Optical Traps Created by a Single Fast Scanning Trap Integrated with the Bilateral Confocal Scanning Laser Miscros. Cytometry 1993, 14, 106-114.
(26) Padgett, M.; Di Leonardo, R. Holographic Optical Tweezers and Their Relevance to Lab on Chip Devices. Lab. Chip 2011, 11, 1196.
(27) Cojoc, D. Dynamic Multiple Optical Trapping by Means of Diffractive Optical Elements. Microelectron. Eng. 2004, 73-74, 927-932.
(28) Hossack, W. J.; Theofanidou, E.; Crain, J.; Heggarty, K.; Birch, M. High-Speed Holographic Optical Tweezers Using a Ferroelectric Liquid Crystal Microdisplay. Opt. Express 2003, 11, 1-7.
(29) Korda, P.; Spalding, G. C.; Dufresne, E. R.; Grier, D. G. Nanofabrication with Holographic Optical Tweezers. Rev. Sci. Instrum. 2002, 73, 1956-1957.
(30) Curtis, J. E.; Koss, B. A.; Grier, D. G. Dynamic Holographic Optical Tweezers. Opt. Commun. 2002, 207, 169-175.
(31) Eriksen, R. L.; Mogensen, P. C.; Glückstad, J. Multiple-Beam Optical Tweezers Generated by the Generalized Phase-Contrast Method. Opt. Lett. 2002, 27, 267-269.
(32) Shaw, L. A.; Spadaccini, C. M.; Hopkins, J. B. Scanning Holographic Optical Tweezers. Opt. Lett. 2017, 42, 2862.
(33) Ghadiri, R.; Guo, Q.; Yeoh, I.; Esen, C.; Ostendorf, A. Process Limitations in Microassembling Using Holographic Optical Tweezers. Proc. SPIE 2012, 8244, 82440L.
(34) Bui, A. A. M.; Stilgoe, A. B.; Khatibzadeh, N.; Nieminen, T. A.; Rubinsztein-Dunlop, H.; Berns, M. W. Optical Tweezers Escape Forces. Proc. SPIE 2014, 9164, 916413.
(35) Grigorenko, A. N.; Roberts, N. W.; Dickinson, M. R.; Zhang, Y. Nanometric Optical Tweezers Based on Nanostructured Substrates. Nat. Photonics 2008, 2, 365-370.
(36) Saija, R.; Denti, P.; Borghese, F.; Maragò, O. M.; Iati, M. A. Optical Trapping Calculations for Metal Nanoparticles. Comparison with Experimental Data for Au and Ag Spheres. Opt. Express 2009, 17, 1-11.
(37) Hansen, P. M.; Bhatia, V. K.; Harrit, N.; Oddershede, L. Expanding the Optical Trapping Range of Gold Nanoparticles. Nano Lett. 2005, 5, 1937-1942.
(38) Hajizadeh, F.; Reihani, S. N. S. Optimized Optical Trapping of Gold Nanoparticles. Opt. Express 2010, 18, 551-559.
(39) Lehmuskero, A.; Johansson, P.; Rubinsztein-Dunlop, H.; Tong, L.; Käll, M. Laser Trapping of Colloidal Metal Nanoparticles. ACS Nano 2015, 9, 3453-3469.
(40) Seol, Y.; Carpenter, A. E.; Perkins, T. T. Gold Nanoparticles: Enhanced Optical Trapping and Sensitivity Coupled with Significant Heating. Opt. Lett. 2006, 31, 2429-2431.
(41) Bosanac, L.; Aabo, T.; Bendix, P. M.; Oddershede, L. B. Efficient Optical Trapping and Visualization of Silver Nanoparticles. Nano Lett. 2008, 8, 1486-1491.
(42) Novotny, L.; Hecht, B. Principles of Nano-Optics; Cambridge University Press: Cambridge, UK, 2012.
(43) Richards, B.; Wolf, E. Electromagnetic Diffraction in Optical Systems II—Structure of the Image Field in an Aplanatic System. Proc. R. Soc. Lond. 1959, 253, 358-379.
(44) Nieminen, T. A.; Loke, V. L. Y.; Stilgoe, A. B.; Heckenberg, N. R.; Rubinsztein-Dunlop, H. T-Matrix Method for Modelling Optical Tweezers. J. Mod. Opt. 2011, 58, 528-544.
(45) Ma, X.; Lu, J. Q.; Brock, R. S.; Jacobs, K. M.; Yang, P.; Hu, X.-H. Determination of Complex Refractive Index of Polystyrene Microspheres from 370 to 1610 Nm. Phys. Med. Biol. 2003, 48, 4165-4172.
(46) Mahamdeh, M.; Campos, C. P.; Schäffer, E. Under-Filling Trapping Objectives Optimizes the Use of the Available Laser Power in Optical Tweezers. Opt. Express 2011, 19, 11759-11768.
(47) Bell, C. G.; Byrne, H. M.; Whiteley, J. P.; Waters, S. L. Heat or Mass Transfer from a Sphere in Stokes Flow at Low Péclet Number. Appl. Math. Lett. 2013, 26, 392-396.
(48) Chen, P. Y.; Keh, H. J. Slow Motion of a Slip Spherical Particle Parallel to One or Two Plane Walls. J. Chin. Inst. Chem. Eng. 2003, 34, 123-133.
(49) McPeak, K. M.; Jayanti, S. V.; Kress, S. J. P.; Meyer, S.; Iotti, S.; Rossinelli, A.; Norris, D. J. Plasmonic Films Can Easily Be Better: Rules and Recipes. ACS Photonics 2015, 2, 326-333.

The following describes some further details, without limitation, of 3D positioning systems according to some embodiments of the current invention.

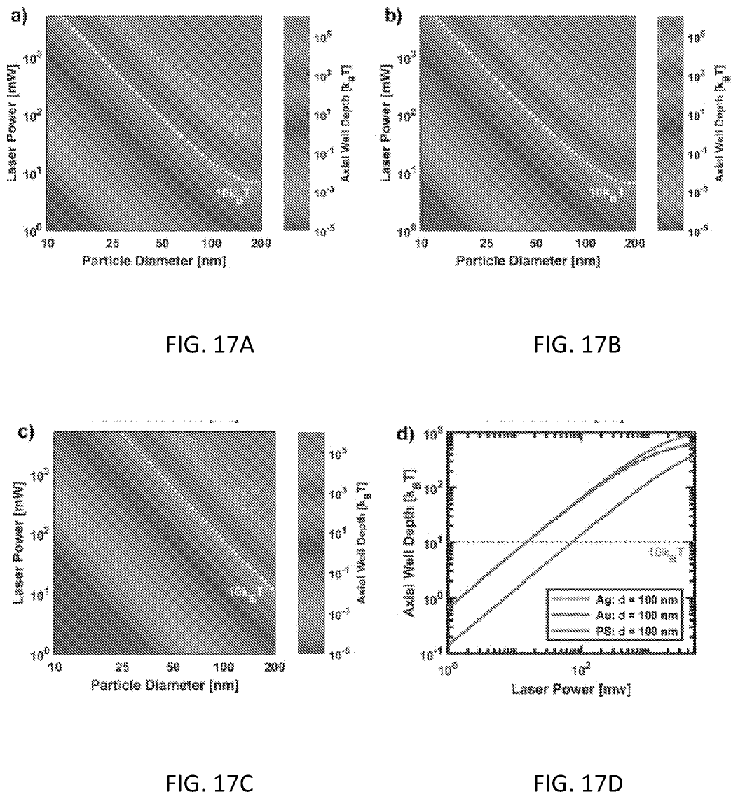

FIG. 18 shows a microscope image of an array of particles that have been attached to a substrate using a system according to an embodiment of the current invention. It helps demonstrate the concept that we can position particles and fix them in place. The particles are 1 micron diameter polystyrene spheres. They are arrayed on a grid with 3 micron×3 micron spacings. The substrate has been functionalized with biotin and the particles functionalized with streptavidin so that they bind.

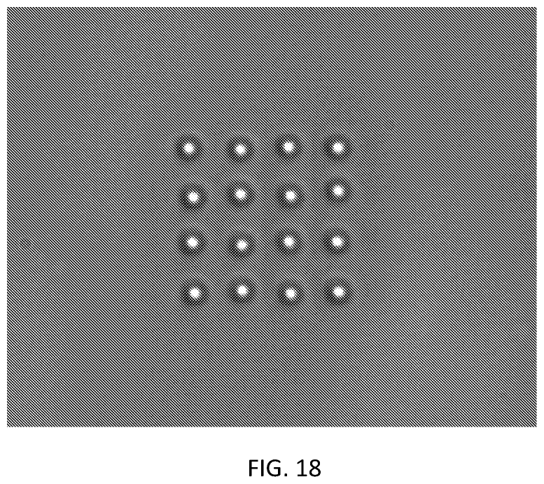

FIG. 19 shows the power spectrum of a 100 nm diameter gold nanoparticle that we have trapped according to an embodiment of the current invention. These data demonstrate that we can use a quadrant photodiode as an automated means of characterizing what type of particle(s) are loaded in the trap according to some embodiments of the current invention. This can be an important feedback mechanism in our automated 3D assembly system because before each building block is added to the structure that we are constructing, we want to make sure that it is just a single particle in the trap and the right size and material.

To generate this figure, we first capture the electrical signal recorded by a quadrant photodiode in our system. This quadrant photodiode is monitoring the back-scattering of the laser light from the optical trap. If there is a particle in the optical trap, the back-scattering will be enhanced and it will show fluctuations according to the Brownian motion of the particle in the trap. Different sizes of particles will experience different levels of Brownian motion, and therefore generate different types of fluctuations in the quadrant photodiode electrical signal. The two panels in this figure represent two different directions of Brownian motion: left-right and up-down. These data come from subtracting the electrical signal from one-half of the quadrant photodiode from the other half. The electrical signal is Fourier transformed so that it can be analyzed in the frequency domain rather than the time domain. The frequency at which the plot begins to “roll off” is called the “corner frequency,” and is denoted as f_c. Different types of particles will exhibit different corner frequencies, and so the corner frequency can be used to identify the type of particle in the trap.

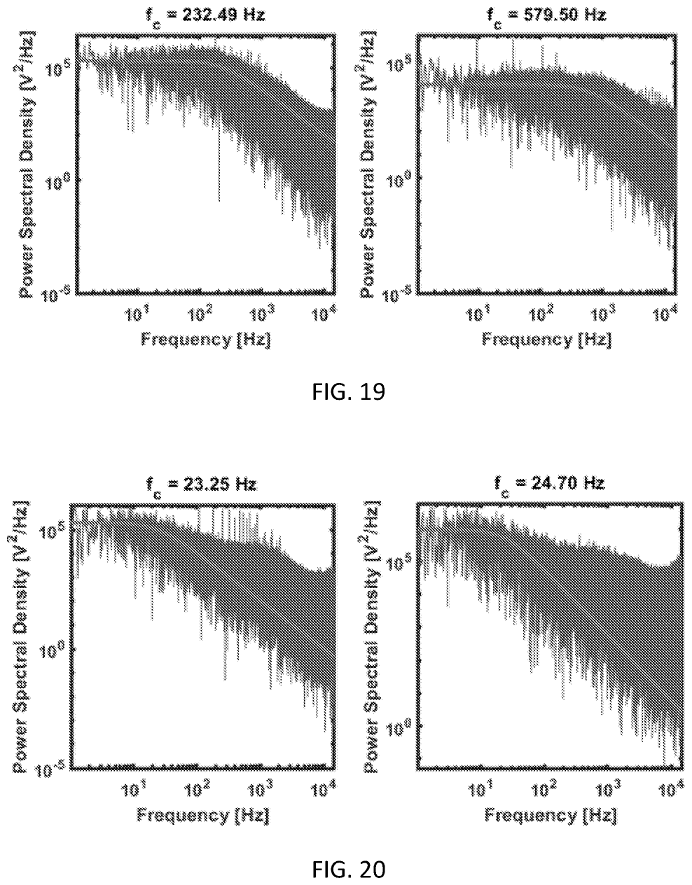

FIG. 20 is similar to FIG. 19, but the particle is a 110 nm diameter polystyrene particle. Because the corner frequencies are significantly different, it demonstrates that we can use the quadrant photodiode to tell the two types of materials apart, despite their similar size.

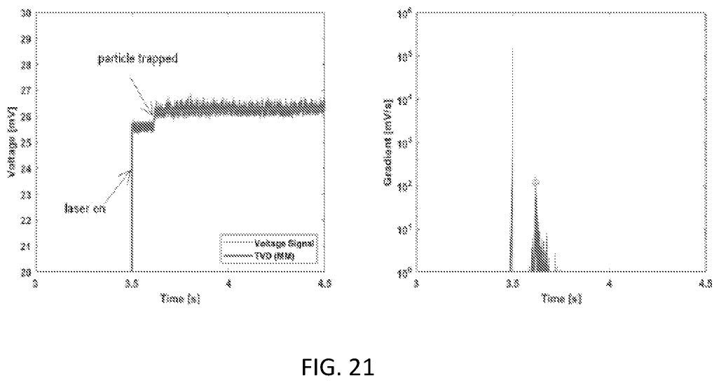

FIG. 21 is again data from a quadrant photodiode, but the data is shown in the time domain and is the total electrical signal over the whole active area of the photodiode, and not a difference signal, as was shown in the previous figures. These data show that we can use a quadrant photodiode as an automated means of determining when the optical trap has been loaded with a particle. There is a significant change in signal when a particle is trapped, providing further confirmation that we can detect particle trapping events in an automated fashion. To do this, we take the raw quadrant photodiode signal (blue line in left panel labeled “Voltage Signal”), and then apply a technique known as total variation denoising to produce the red-orange curve (labeled “TVD (MM)”). We then numerically compute the slope of this red-orange curve to produce the data shown in the right panel. The red circle in the right panel shows that by simply identifying spikes in the slope of the red-orange curve (disregarding the laser-on event), we can automatically identify when a particle is loaded into the trap. This event then triggers an automated placement program to place that particle in the desired location.

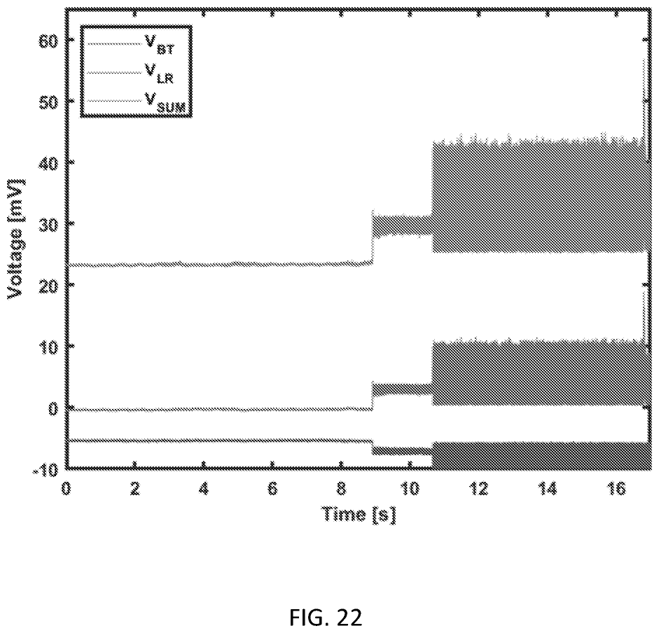

FIG. 22 shows more time-series data from a quadrant photodiode. It shows both difference signals (V_BT and V_LR) as well as the total photodiode signal (V_SUM). These data show that we can differentiate between a single particle in the trap and multiple particles in the trap. In one embodiment, our system is designed to only place one building block at a time, and if there is more than one building block in the trap, it will lead to errors in the final structure. To prevent these errors, it is useful to have an automated means of detecting when more than one particle is in the trap. In the figure, at approximately 9 s, the first particle enters the trap, while a second particle enters the trap at approximately 11 s.

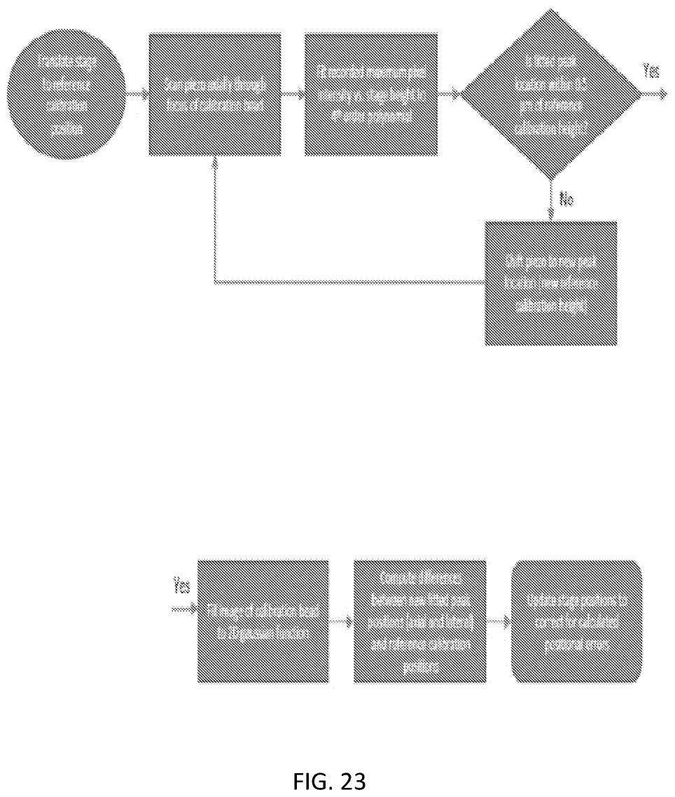

FIG. 23 shows our procedure for recalibrating our positioning system according to an embodiment of the current invention. It shows how we reduce our positional error. We run this algorithm before placing each building block. In an embodiment of our system, we need to have positional accuracies significantly better than 100 nm, however most nanopositioning stages accumulate significant positional error if they move a long distance (tens or hundreds of microns) and then return to the original location. We do this each time we pick up a new building block. In order to account for this accumulated error, we perform an image-based recalibration procedure on a reference particle that has been adhered to the substrate. This powerpoint slide shows the flow chart for this recalibration procedure, which corrects for errors in all 3 dimensions (x, y, and z).

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A method of designing a nano-structured optical device, comprising:
selecting a first nanoscale building block from a finite set of types of building blocks, wherein each type of building block has at least a defined shape, size and compositional material characteristic;
placing said first nanoscale building block at a position and orientation in a three-dimensional optical device structure;
optimizing said position, orientation, and type of said first nanoscale building block to obtain a preselected optical effect based on optical scattering from said first nanoscale building block;
selecting a second nanoscale building block from said finite set of types of building blocks;
placing said second nanoscale building block at a position and orientation in said three-dimensional optical device structure along with said first nanoscale building block;
optimizing said positions, orientations, and types of said first and second nanoscale building blocks to obtain said preselected optical effect based on optical scattering from said first and second nanoscale building block,
wherein said optical device designed has said three-dimensional optical device structure.

2. The method according to claim 1, further comprising repeating said selecting, placing and optimizing a plurality of times to provide said design of said optical device.

3. The method according to claim 1, wherein all of said selecting, placing and optimizing are performed virtually using at least one computer.

4. The method according to claim 1, wherein said optimizing includes performing a plurality of calculations in which each said building block is approximated as an electric dipole which can interact with other approximated electric dipoles within said three-dimensional optical device structure.

5. The method according to claim 1, wherein all of said selecting, placing and optimizing are performed physically using a nano-assembly system.

6. The method according to claim 5, wherein said nano-assembly system comprises a microfluidic building-block delivery system and an optical tweezers building-block positioning system.

7. The method according to claim 3, further comprising storing a production plan for said three-dimensional optical device structure for use with controlling a manufacturing system.

8. A nano-assembly system, comprising:
a nano-scale-building-block selection and delivery system having an input section and an assembly region;
a nano-positioning system arranged proximate said assembly region; and
a nano-assembly control system configured to communicate with said nano-scale-building-block selection and delivery system to select nano-scale building blocks to be delivered to said assembly region according to an assembly plan,
wherein said nano-assembly control system is further configured to communicate with said nano-positioning system for said nano-positioning system to position nano-scale building blocks that have been delivered to said assembly region according to said assembly plan.

9. The nano-assembly system according to claim 8, wherein said nano-scale-building-block selection and delivery system is a microfluidic system comprising a plurality of input and delivery channels each connected to a source of a type of nano-scale building block at said input section, said plurality of input and delivery channels all being connected to said assembly region.

10. The nano-assembly system according to claim 8, wherein said nano-positioning system comprises optical tweezers to move said nano-scale building blocks into positions based on said assembly plan.

11. The nano-assembly system according to claim 8, wherein said assembly plan is based a method of designing a nano-structured optical device, comprising:
selecting a first nanoscale building block from a finite set of types of building blocks, wherein each type of building block has at least a defined shape, size and compositional material characteristic;
placing said first nanoscale building block at a position and orientation in a three-dimensional optical device structure;
optimizing said position, orientation, and type of said first nanoscale building block to obtain a preselected optical effect based on optical scattering from said first nanoscale building block;
selecting a second nanoscale building block from said finite set of types of building blocks;
placing said second nanoscale building block at a position and orientation in said three-dimensional optical device structure along with said first nanoscale building block;
optimizing said positions, orientations, and types of said first and second nanoscale building blocks to obtain said preselected optical effect based on optical scattering from said first and second nanoscale building block,
wherein said optical device designed has said three-dimensional optical device structure.

12. The nano-assembly system according to claim 11, wherein said assembly plan is based said method of designing said nano-structured optical device, further comprising repeating said selecting, placing and optimizing a plurality of times to provide said design of said optical device.

13. The nano-assembly system according to claim 12, wherein all of said selecting, placing and optimizing are performed virtually using at least one computer.

14. (canceled)

15. A method of producing a nano-structured device, comprising:
receiving a production plan;
selecting a first nanoscale building block from a finite set of types of building blocks using said production plan, wherein each type of building block has at least a defined shape, size and compositional material characteristic;
placing said first nanoscale building block at a position in a three-dimensional device structure using said production plan;
selecting a second nanoscale building block from said finite set of types of building blocks using said production plan;
placing said second nanoscale building block at a position in said three-dimensional device structure along with said first nanoscale building block using said production plan; and
repeating said selecting, placing and optimizing a plurality of times using said production plan to provide said nano-structured device.

16. The method of producing a nano-structured optical device according to claim 15, wherein said production plan is based on a method of designing a nano-structured optical device, comprising:
selecting a first nanoscale building block from a finite set of types of building blocks, wherein each type of building block has at least a defined shape, size and compositional material characteristic;
placing said first nanoscale building block at a position and orientation in a three-dimensional optical device structure;
optimizing said position, orientation, and type of said first nanoscale building block to obtain a preselected optical effect based on optical scattering from said first nanoscale building block;
selecting a second nanoscale building block from said finite set of types of building blocks;
placing said second nanoscale building block at a position and orientation in said three-dimensional optical device structure along with said first nanoscale building block;
optimizing said positions, orientations, and types of said first and second nanoscale building blocks to obtain said preselected optical effect based on optical scattering from said first and second nanoscale building block,
wherein said optical device designed has said three-dimensional optical device structure.

17. The method according to claim 16, wherein said production plan further comprises repeating said selecting, placing and optimizing a plurality of times to provide said design of said optical device.

18. The method according to claim 17, wherein all of said selecting, placing and optimizing are performed virtually using at least one computer.

19. The method according to claim 16, wherein said optimizing includes performing a plurality of calculations in which each said building block is approximated as an electric dipole which can interact with other approximated electric dipoles within said three-dimensional optical device structure.

20. The method according to claim 15, further comprising providing at least one of a substrate or a scaffold structure to provide support structure to each of said building block.

21. The method according to claim 20, further comprising functionalizing said plurality of nanoscale building blocks and functionalizing at least one of said substrate and said scaffold to effect assembly according to said production plan.

22. (canceled)

23. (canceled)
